(19) United States
(12) Patent Application Publication
(10) Pub. No.: US 2004/0249505 A1
(43) Pub. Date: Dec. 9, 2004

(54) Method and system for water management

(76) Inventor: Yehuda Sardas, Beit Dagan (IL)

Correspondence Address: Kevin D McCarthy, Roach Brown McCarthy & Gruber, 1620 Liberty Building, Buffalo, NY, 14202, US

(21) Appl. No.: 10/481,095

(22) PCT Filed: Jun. 27, 2002
(86) PCT No.: PCT/IL02/00519

(30) Foreign Application Priority Data
Jun. 28, 2001 (IL) 144069
Jan. 28, 2002 (IL) 147874

(51) Int. Cl. A01G 31/00

(52) U.S. Cl. 700/245

(57) ABSTRACT

A method and system is disclosed for water-efficient water management for plants grown in at least one container. At least one water inlet and at least one drainage opening is provided for each of the containers, such that a drainage opening divides particulate material contained within a container into a lower saturated layer and an upper, relatively dry layer. A water level gauging means is provided in each container, to gauge the depth of the layer of water existing at the bottom, as well as a water control means to add water to each container as a result of the reading of the water level gauging means, so as to maintain a desired level of water at the bottom of the gauged container, without resulting in a deleterious rise in chloride level. Plagiotropically growing root hairs extend into, and are entwined with the saturated layer of particulate material to form a biomass.

### FIELD OF THE INVENTION

The present invention relates to the field of plant growing. More particularly, the invention relates to a method and system for water management that reduces water usage needed for the growth of plants by controlling the water level within a plurality of containers in each of which plant growth is cultivated, corresponding to the particular needs of the given plant, without any deleterious rise in chlorides.

### BACKGROUND OF THE INVENTION

Irrigated agriculture has been an important source of food production over recent decades. The highest yields that can be obtained from irrigation are more than double the highest yields that can be obtained from rainfed agriculture. The advantages of irrigation are a result of the ability of controlling, quite precisely, the water intake of plant roots.

There are basically five types of irrigation presently in use:

1) Surface irrigation by which the entire crop area is flooded;

2) Sprinkler irrigation, which imitates rainfall;

3) Drip irrigation, in which water is dripped onto the soil above the root zone only;

4) Underground irrigation of the root zone by means of perforated pipes placed in the soil;

5) Sub-irrigation, in which the groundwater level is raised sufficiently to dampen the root zone.

The first two, surface and sprinkler irrigation, are known as conventional irrigation. Surface irrigation is the most common technique, and is used by small farmers since it does not involve the operation and maintenance of sophisticated hydraulic equipment. However, this method, and sprinkler irrigation on a smaller scale, is wasteful of water.

Drip irrigation and underground irrigation are examples of localized irrigation by which water efficiency is greatly improved because water is applied only to those areas where it is needed and only a relatively small amount is wasted. Drip irrigation depends on a pressurized system to force water through perforated pipes running above ground, at rates of 1-10 liters per hour per emitter. Farmers who have converted their watering systems from conventional irrigation to drip irrigation have reduced their water usage by 30 to 60 percent. Even though the technology is simple, drip irrigation requires careful maintenance of equipment since the emitters can become easily clogged.

As water is becoming scarce on a worldwide basis, there is a need for further improving water efficiency.

One prevalent method of reducing water usage involves the utilization of wastewater. Treated wastewater includes concentrates of nutrients that could serve as a fertilizer, and additional water savings of more than 20 percent may be realized. However, this method requires high capital costs such as a tank to hold the wastewater, a pump and piping system for the circulation thereof, etc. Also extensive labor costs are expended to test and treat the wastewater.

PCT Patent Application WO 99/51080 discloses a method, which is incorporated herein by reference, for producing cultivation areas on flat surfaces. The method of WO 99/51080 presents the drawback when applied to various types of plant growth, which are grown in different densities with variable water requirements, that the water usage is difficult to be controlled in an optimal manner within a static system. Therefore, there is still a need for improvements that will prevent water waste, particularly in agricultural mass production.

Another problem with which the growth of edible vegetables in containers is faced, is the build-up of impurities and the change in pH, due to the need to supply nutrient materials in the water supplied to the vegetable.

This build-up and pH change may result in a harmful environment, which may damage the vegetable and its fruits. Because of these facts, washing of the containers and replacement of the particulate material in which the vegetables grow is a periodic necessity.

It has been now surprisingly found that it is possible to grow any type of greenery in containers using a substantially lower amount of irrigation water, while maintaining the yield achieved with prior art methods, and even improving upon it.

It has further been most surprisingly found that it is possible to achieve the aforesaid goals while avoiding a deleterious rise in chlorides and other impurities, which results in a more convenient method of cultivation and in reduced costs.

It is therefore an object of the present invention to provide a method and system to improve water utilization for plant growth.

It is an additional object of the present invention to provide a water management system which overcomes the disadvantages of prior art systems.

It is a further object of the invention to provide a water management system which does not result in a deleterious rise in chlorides and other impurities.

Other objects and advantages of the invention will become apparent as the description proceeds.

### SUMMARY OF THE INVENTION

Hereinafter, for purposes of description, reference will be made to garden vegetables such as tomatoes and cucumbers as the plant growth, but this should be understood to be a preferred example and not a limitation since this invention is suitable for the growth of any type of plant growth including vegetables, herbs, grass, flowers, grains, cotton and trees.

The present invention relates to a water-efficient method for growing plants in at least one container, comprising the steps of:

a) providing at least one container filled with particulate material;

b) providing at least one water inlet and at least one drainage opening to each of said containers, wherein said at least one drainage opening divides said particulate material into a lower saturated layer and an upper, relatively dry layer;

c) providing, in one or more of said containers, water level gauging means to gauge the depth of the layer of water existing at the bottom of said one or more containers;

d) planting plant growth in said containers; and

e) adding water to each of said containers as a result of the reading of said water level gauging means, so as to maintain a desired level of water at the bottom of the gauged container.

The porous bed, in which a plant is grown, is made of particulate inert or active material, which can also be a mixture or blend of two or more different materials. The ratio of the weight of water that fills the pores of the particulate material to the weight of the dry porous bed, for a given volume, hereinafter referred to as “water holding capacity,” is at least 0.035. For instance, the water holding capacity of a blend of large leca and perlite is 0.326, while that of a blend of perlite and peat is 1.840.

According to a preferred embodiment of the invention, the particulate material is a substrate that possesses capillarity. Said substrate will prevent the harmful accumulation of chlorides at the bottom of a container in which plant growth is being cultivated.

A substrate is considered to “capillaric” if the rate of capillarity of water that permeates vertically upwards therein is at least 2 cm/day, and preferably at least 2.5 cm/day.

Drainage openings are provided at a level intermediate between the top and bottom of the porous bed to functionally divide said bed into a bottom layer containing a liquid (which is generally water or an aqueous solution), hereinafter referred to as a “saturated layer” and an upper layer, the pores of which are relatively free of liquid and are relatively open and aerated, viz. filled with gas or vapor, hereinafter referred to as a “relatively dry layer”. The roots of the plant growth extend into the lower layer and become entwined therewith.

As said, the said porous bed consists of two distinct layers and is preferably saturated with water or with an aqueous solution up to a predetermined and controlled level. A liquid level regulator is employed to maintain an optimal level of liquid for the desired plant growth. A drainage means, e.g., a drainage hole, is provided for draining water from said bed at said predetermined level, whereby to maintain an upper layer of said porous bed having relatively open and aerated pores. For example, a water level of 3.5 cm is maintained for the growth of tomatoes and cucumbers. If the water level is lower than this value, the water evaporates and the growth of the vegetables is stunted, whereas if the water level is higher than this level the roots begin to decompose, and at a level of approximately 5 cm the plant decays. It has been surprisingly found, and this is the object of the present invention, that the water usage of vegetable growth grown in said porous bed with the utilization of a liquid level regulator ranges from approximately one-fourth to one-fifth the water usage of vegetable growth grown in a conventional manner, regardless of the type of irrigation in use.

Of course, said relatively dry layer of the porous bed may be moist, due to the permeation and evaporation from the saturated water layer, and further the porous bed may absorb different amounts of water, depending on its physical properties. Thus, the fact that a layer is aerated does not mean that it is free from any moisture level. The surface on which the area is to be provided may be rendered water-impermeable by any suitable technique, e.g., by providing a bottom sheet of plastic or other impermeable material on which the particulate material is positioned, or by applying to it a layer of water impermeable material.

It should be understood that the term “container”, as used herein, designates any structure having any imaginable surface area that can retain therein water and consequently a porous bed containing water. Such an element may a) comprise a bottom and side walls connected thereto, viz. have a basin-like structure; b) be constituted by an independent bottom such as a sheet of waterproof material and a border formed around it, e.g. by a number of border walls, defining a basin-like space; c) be constituted by an area of a surface, waterproofed, in which a vegetable growth is to be planted, and a border formed around it, e.g. by a number of border walls, said surface area constituting a bottom; or d) be formed on the surface, in which a vegetable growth is to be planted, by a depression having a bottom and a border. The term “container” in this specification and claims should always be understood to include all the aforesaid variants, and in general any structure or means (generally defining a basin-like space) that can retain therein water, and consequently retain a porous bed filled with water, and which further comprises drainage means, such as orifices, at a predetermined height, as further explained herein—unless a narrower construction of the term is specified.

If the container has a basin-like structure, comprising a bottom and border, the provision of the desired greenery area is effected by placing the porous bed and the vegetable growth therein and then placing the container on a surface, in any desired position, as long as it is horizontally balanced and level. Alternatively, the porous bed and/or the vegetable growth may be laid in the container after the container is placed on the surface. The surface, as has been said, may be a building surface. It can also be an artificial surface other than that of a building, or a natural surface that is or has been rendered level. If the container is defined by a bottom and border not structurally connected, as when the bottom is a waterproof sheet or is an area of the building surface, it will be completed by providing, if necessary, the border walls, and then the porous bed and the vegetable growth will be placed into the thus completed container.

According to a particular preferred embodiment of the invention, an upper tier of the porous bed is provided within a meshed structure that may have a small area. In this way, the upper tier can be made modularly of small areas of particulate beds, laid side by side, which facilitates the setting up of the surface. Additionally, since the upper tier is essentially contained in a meshed structure, the roots of the vegetable growth enter this structure and are eventually intertwined therewith.

The treatment to which the vegetable growth is subjected after being put in place includes, besides providing a necessary water level to permeate said porous bed, the treatments that are generally applied to similar vegetable growth, when cultivated in the conventional way. In addition to fertilization, protective chemicals, such as weed killers and/or pesticides, may be applied to the vegetable growth. The fertilizer is preferably liquid, which is added to the water line by a fertilization pump at such a flow rate so as to maintain a predetermined concentration of fertilizer within the water. A reduction in water usage through usage of the present invention results in a concomitant reduction in fertilizer usage.

As explained above, it has been further surprisingly found there is no deleterious rise in the chloride level even though the layer of water is at times substantially stagnant, despite the release of organic matter as a result of fertilization, if a capillaric substrate is employed. Since the water level corresponds to the actual water absorption needed by the plant, there is no excess water that normally causes a steep rise in chlorides and nitrates. As well known, various types of chlorides are dissolved within tap water and normally dissociate within stagnant water into anions and cations, which increase the electrical conductivity of water. Under normal circumstances, during which water continues to evaporate, the chloride level of the remaining water increases since chlorides have a much higher evaporation point than water and remain therein. However, with the use of the present invention and a capillaric substrate, chlorides accumulate at the top of the substrate, while the chloride concentration is minimal within the saturated layer, wherein a thick mass of roots grow. According to an explanation of the phenomenon reflected by the present invention, water together with the associated chlorides permeate the particulate material, and capillary force drives the chlorides upward towards the upper surface of the substrate. The chloride level within the controllable level of water does not significantly increase since the rate of capillarity is substantially equal to the rate of water influx into the corresponding container, and therefore there is a turnover of dissolved chlorides therein to thereby prevent a deleterious rise in chloride level.

When a top tier is provided with a particulate material having a water adsorption of at least 200% by weight, chlorides are able to be easily removed after having been concentrated in said top tier, particularly if the top tier has an apparent density ranging from 40 to 170 kg/m³. Accordingly, said top tier is preferably removed upon conclusion of a plant growing season and then the bottom tier may be reused during a subsequent growing season after a different top tier is provided and another plant growth is planted in said different top tier.

The present invention also relates to water-efficient water management system for growing plants in at least one container, comprising:

a) at least one container wherein each of which is suitable to contain a bed of particulate material;

b) at least one water inlet and at least one drainage opening to each of said containers, wherein said at least one drainage opening divides said particulate material into a lower saturated layer and an upper, relatively dry layer;

c) water level gauging means provided in one or more of said containers, to gauge the depth of the layer of water existing at the bottom of said one or more containers; and

d) water control means to add water to said containers as a result of the reading of said water level gauging means, so as to maintain the desired level of water at the bottom of the gauged container.

The water control means preferably is at least one control valve and the water level gauging means is at least one sensor, said at least one control valve being operative in response to said at least one sensor to admit an additional amount of water to a corresponding container at a predetermined flow rate for a predetermined duration when the water level falls below a first predetermined value.

If desired, the temperature of the water used for irrigating the greenery can be controlled, to maintain the temperature of the vegetable growth within optimal limits; and for this purpose, heating means can be provided and activated in the appropriate seasons, to prevent the root temperature from becoming too low.

The container is provided with a first set of drainage apertures to maintain the water inside the container at no more than a predetermined level so that a top layer of porous material will have liquid-free, aerated pores, as set forth above. A second set of “normally-closed” drainage apertures can be provided within the bottom of said container for complete drainage of water from the container, if so desired.

The present invention also relates to a water supply controller suitable to control the supply of water to a plant growth vessel in response to a water level indication of a body of water in said vessel, wherein said vessel comprises vessel walls, a vessel bottom, a bed of porous material contained in said vessel, and a plant growth disposed in said bed of porous material. The water supply controller is operative to control the actuation of a control valve in response to said water level indication and comprises a microprocessor, software for programming the actuator in a preferred manner, a local memory and a means of communicating with the control valve actuator and water level indication.

The present invention is also directed to a root-mutated plant, wherein a primary root has branched into secondary roots and the secondary roots have developed into plagiotropically, i.e. in a lateral direction, growing root hairs characterized by a fibrous root system, said secondary roots being capable of growing and extending through a bed of porous material contained in a vessel at the bottom of which a predetermined level of water. is controllably maintained, said root hairs being capable of extending into, and being entwined with, a layer of said porous material saturated by said level of water, whereby to form a biomass within said saturated layer.

In one aspect, the primary root of a tap root system has branched into root hairs of a fibrous root system.

The present invention is also directed to a root-mutated plant growth, induced by:

a) a container filled with particulate material;

b) at least one water inlet and at least one drainage opening provided in said container; and

c) water control means to add water to said container, so as to maintain the desired level of water at the bottom of the gauged container,

wherein a primary root branches into secondary roots and the secondary roots develop into plagiotropically growing root hairs characterized by a fibrous root system, said secondary roots capable of growing and extending through said particulate material, said root hairs extending into and being entwined with a layer of said particulate material saturated by said level of water, whereby to form a biomass within said saturated layer.

Also encompassed by the invention are plants having mutated roots obtained according to the invention.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a schematic diagram of one preferred embodiment of the water management system shown in plan view;

FIG. 2 is a cross-sectional view of a plurality of containers, cut along plane A-A of FIG. 4, showing the placement of the water inlet at a varying height within each of the containers;

FIG. 3 shows an arrangement in which the containers are separated from one another, and water flows into the containers through appropriate water pipes;

FIG. 4 is a plan view of a container, when empty, showing a level switch and a drainage unit;

FIG. 5 is a cross-sectional view of a container, cut along plane B-B of FIG. 4, illustrating the particulate material and vegetable growth;

FIG. 6 is a picture of the roots of a plant grown with the use of the present invention;

FIG. 7 is a picture of the roots when they are removed from a container;

FIG. 8 is a picture of the root formation after the particulate material is removed therefrom;

FIG. 9 is an enlargement of FIG. 2 showing a body of water, illustrating a change in water level;

FIG. 10 is a schematic diagram of another preferred embodiment of the invention in which a single control valve and sensor are used;

FIG. 11A is a perspective view of a capacitive transduction sensor used in conjunction with the water management system of the present invention and FIG. 11B is a top view of the same, showing the water column inlet;

FIG. 12 is a perspective view of a container to which a capacitive transduction sensor is mountable;

FIG. 13 is a perspective view of a container to which a capacitive transduction sensor is mounted;

FIG. 14 is a longitudinal cross sectional view of a capacitive transduction sensor, cut along plane C-C of FIG. 11B;

FIG. 15 is a schematic diagram of yet another preferred embodiment in plan view of the invention in which a controller and a plurality of sensors are employed to control the inflow of water into the set of containers;

FIG. 16 is a schematic diagram of yet another preferred embodiment of the invention in which a sensor is disposed in each container;

FIG. 17 is a schematic diagram of another preferred embodiment in which a controller controls the actuation of a plurality of control valves;

FIG. 18 is a schematic diagram of an additional embodiment of the present invention in which a controller controls the inflow of water into a plurality of sectors of containers from two separate water lines;

FIG. 19 is a schematic diagram of a heating system for the control of the water temperature of a body of water contained in a container;

FIG. 20 is a graph illustrating a change in chloride concentration obtained in Example 2 of the present invention over a period of time for a substrate of large leca, in which tomato plants were grown, according to the present invention;

FIG. 21 is a graph illustrating a change in chloride concentration obtained in Example 2 of the present invention over a period of time for a substrate of tuff, in which tomato plants were grown, according to the present invention;

FIG. 22 is a graph illustrating a change in chloride concentration obtained in Example 2 of the present invention over a period of time for a substrate of tuff and perlite (1:1, v:v), in which tomato plants were grown, according to the present invention;

FIG. 23 is a graph illustrating a change in chloride concentration obtained in Example 2 of the present invention over a period of time for a substrate of tuff and peat (1:1, v:v), in which tomato plants were grown, according to the present invention;

FIG. 24 is a graph illustrating a change in chloride concentration obtained in Example 2 of the present invention over a period of time for a substrate of leca and peat (1:1, v:v), in which tomato plants were grown, according to the present invention;

FIG. 25 is a graph illustrating a change in chloride concentration obtained in Example 2 of the present invention over a period of time for a substrate of leca and perlite (1:1, v:v), in which tomato plants were grown, according to the present invention;

FIG. 26 is a graph illustrating a change in chloride concentration obtained in Example 2 of the present invention over a period of time for a substrate of peat and perlite (1:1, v:v), in which tomato plants were grown, according to the present invention;

FIG. 27 is a graph illustrating a change in chloride concentration at different locations, each of which corresponding to a different height above a container bottom, obtained in Example 3 of the present invention over a period of time for a bottom tier of peat and tuff (1:1, v:v) and an upper tier of perlite, in which tomato plants were grown, according to the present invention;

FIG. 28 is a graph which compares the rate of capillarity of water obtained in Example 4 of the present invention within five separate substrates.

FIG. 29 is a graph illustrating typical winter yields obtained in Example 7 of the present invention;

FIG. 30 compares the total water consumption obtained in Example 8 of the present invention, for tomatoes grown in the summer, between a prior art method and the method of the present invention;

FIG. 31 compares the total water consumption obtained in Example 8 of the present invention, for cucumbers grown in the summer, between a prior art method and the method of the present invention;

FIG. 32 compares the mean daily water consumption obtained in Example 8 of the present invention, for tomatoes grown in the summer, between a prior art method and the method of the present invention;

FIG. 33 compares the mean daily water consumption obtained in Example 8 of the present invention, for cucumbers grown in the summer, between a prior art method and the method of the present invention;

FIG. 34 compares yield data obtained in Example 8 of the present invention, for tomatoes grown in the summer, between a prior art method and the method of the present invention;

FIG. 35 compares yield data obtained in Example 8 of the present invention, for cucumbers grown in the summer, between a prior art method and the method of the present invention;

FIG. 36 compares the yield ratio, for tomatoes grown in the summer, between a prior art method and the method of the present invention; and

FIG. 37 compares the yield ratio, for tomatoes grown in the summer, between a prior art method and the method of the present invention.

### DETAILED DESCRIPTION OF PREFERRED EMBODIMENTS

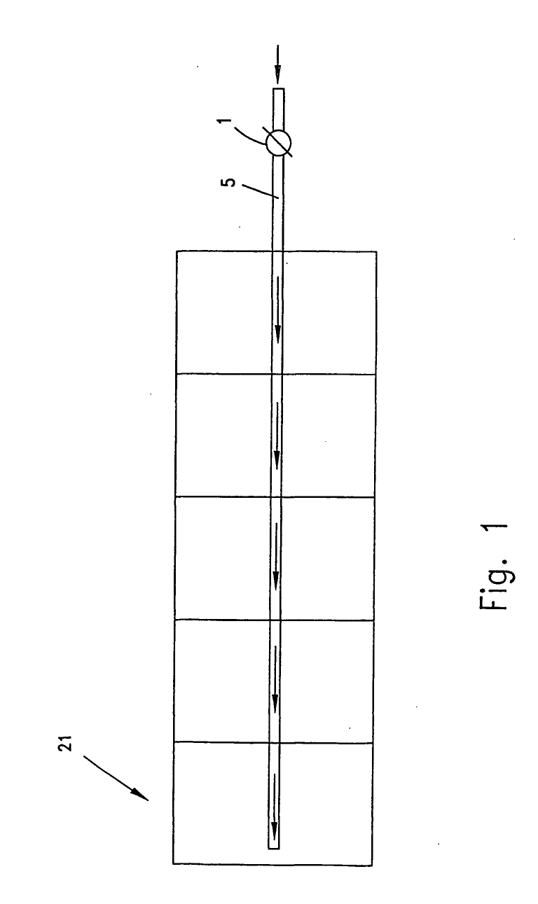

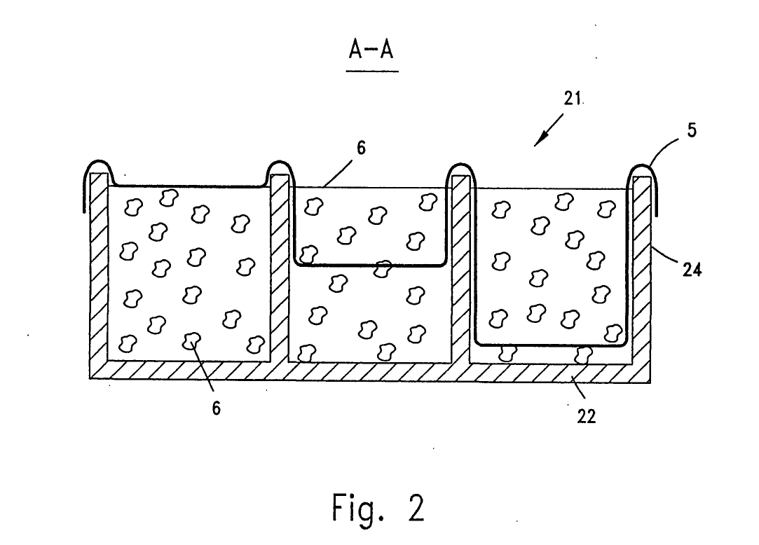

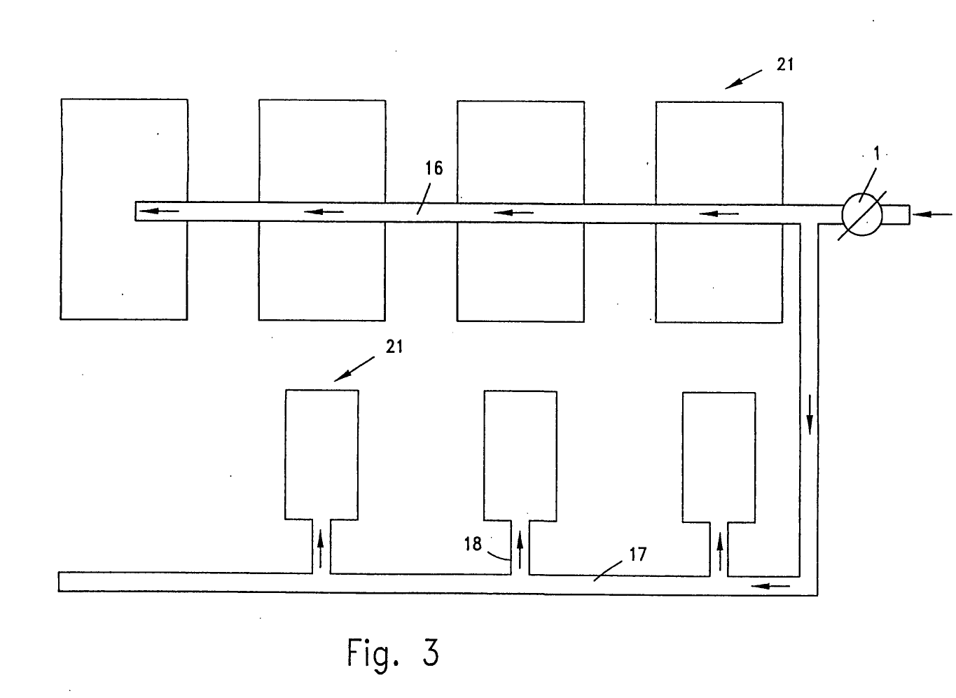

One preferred embodiment of the water management system of the invention is illustrated schematically in FIG. 1. As valve 1 is opened, water flows in series via water conduit 5 into set of containers 21, each of which containers is juxtaposed one to another. Conduit 5 is preferably a flexible hose and branches to allow for connection to the irrigation means of each container. Adjacent containers may be fastened to each other, e.g. by bolts or by bonding. As shown in FIG. 2, conduit 5 may be bent in such a fashion so that it passes over container wall 24 and imbedded within particulate material 7, at a predetermined height above container bottom 22, or laid on top of particulate material surface 6. Alternatively, conduit 5 is a pipe, e.g. made from cast iron or plastic, that passes from one container to another through an opening (not shown), which is preferably sealed to minimize loss of water. When growing in greenhouses or other conventional arrangements, the various containers 21 may be typically individually placed within the growing area, and are not connected to one another. This is shown in FIG. 3, in which the various containers 21 do not touch one another. Water supply line 16 may run through the various containers, or may run separately through main line 17, which subdivides into branches 18, such that each branch 18 supplies water to a corresponding container 21. The water inlet into each container is connected to a corresponding irrigation means.

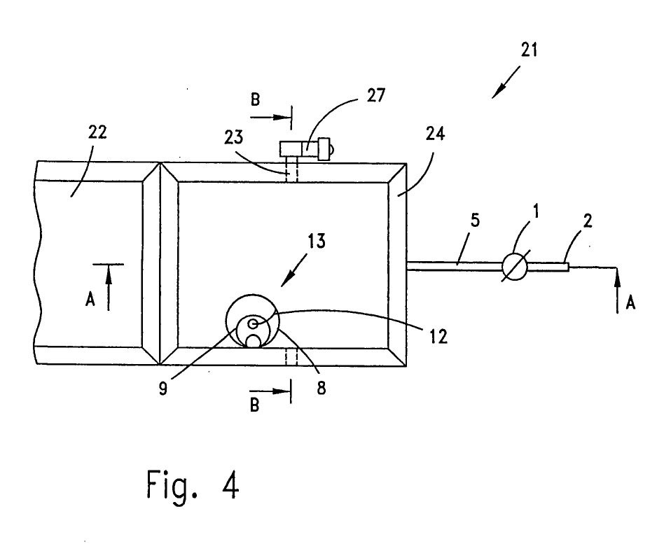

Each container 21, which forms a part of the apparatus according to this embodiment of the invention, is a deep basin-like body, which may have a rectangular shape in plan view, as shown in FIG. 4. The container can be made of any suitable material, such as plastic, expanded polystyrene, etc. The shape of the container depends on the particular arrangement which it is intended to use, and it may be provided with any preferred cross-section, e.g. circular. Similarly the surface area and height of the container are variable and depend on the application for which it is used. For example, a container having a surface area of 0.5 m² and height of 20 cm for vegetables, of 0.3 m² and a height of 80 cm for a grapevine and a surface area spanning 1000 m² for melons may be used to enclose the porous bed for that particular plant growth.

Container 21 is also provided with a sensor for water level regulation, which will be described hereinafter. In this embodiment the sensor is a level switch, designated by 13, which comprises a float 8, cable 12, and sensor housing 9. Sensor housing 9, which has a cavity and can be provided with any preferred shape such as the illustrated cylindrical configuration, is partially open at its bottom and allows water to enter therein. Float 8 rises and descends within sensor housing 9 in response to the water level therein. The sensitivity of level switch 13 to fluctuations in the water level within sensor housing 9 can be selected, preferably is such that the rate of water influx into container 21 is substantially equal to the rate of water level decrease therein, as will be described hereinafter. Cable 12 may be connected to an alarm to indicate whether the water level is within a permissible range. If the water level is within a permissible range valve 1 is preferably closed.

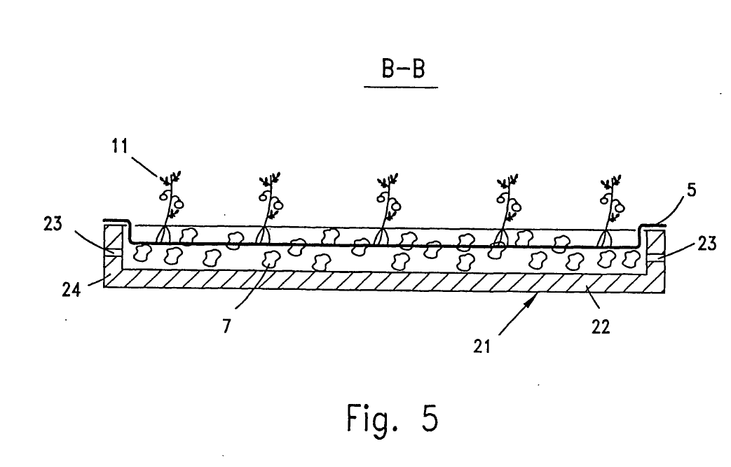

As seen in FIG. 5, each container 21 is filled, in this embodiment, with particulate, porous and inert material, which may consist, for example, of peat, tuff, perlite or leca, or of mixtures or blends thereof. Table I below delineates the density of various types of illustrative bedding suitable for use with the water management system of the present invention. As referred to herein, “tuff” refers to pulverized magmatic rock material, wherein “large tuff” is defined as grains that have a size dispersion ranging from 4-20 mm and “small tuff” is defined as grains that have a size dispersion ranging from 4-8 mm. As referred to herein, “leca” refers to a clay which is dried and burned in rotary kilns such that it is expanded into a lightweight aggregate, wherein “large leca” is defined as grains that have a size of approximately 15 mm and “small leca” is defined as grains that have a size of approximately 5 mm. As referred to herein, “perlite” refers to a white mineral which is formed by heating siliceous rock to a suitable point in its softening range such that it expands from four to twenty times its original volume.

Between Mar. 23-25, 2001 data was compiled regarding the water holding capacity (WHC) of various types of bedding. WHC is an indication of how much water is readily available to the plants being grown in the bedding, particularly for seedlings whose roots do not extend into the layer of water, as will be described, hereinafter. The weight of water that was absorbed by 1 liter of the bedding was determined by subtracting the weight of a saturated bedding from a dry bedding. WHC is defined as the ratio of the absorbed water to the dry bedding. A marked increase in WHC was realized by the addition of peat. Plants were able to grow in a bedding having a WHC having at least 0.035. For instance, the water holding capacity of a blend of large leca and perlite is 0.326, while that of a blend of perlite and peat is 1.840. Plants were not able to grow in non-porous ground because the roots were not able to penetrate the particulate bedding material.

Said particulate material may be arranged in a single tier designated by 7 having a homogeneous composition, when a mixture is used. For example, a mixture of perlite and peat having a density of 231 gm/liter may be used for vegetable growth and a mixture of tuff and peat having a density of 619 gm/liter may be used for the growth of grapes. However, the particulate material may also be arranged in two tiers, each of which has a different particle size. For example, if the material is tuff, the bottom tier 25 consists of

TABLE I

| | DENSITY | | WATER | WHC (%) |
|---|---|---|---|---|
| | (gm/liter) | | Content | Water holding |
| BEDDING | Dry | Saturated | (gm) | capacity |
| Sand | 1135 | 1175 | 40 | 3.5 |
| Small Tuff | 922 | 1004 | 83 | 9.0 |
| Large Tuff | 826 | 902 | 76 | 9.1 |
| Large Tuff + Peat | 797 | 1168 | 371 | 46.6 |
| Large Tuff + Perlite | 775 | 920 | 145 | 18.7 |
| Small Tuff + Perlite | 635 | 771 | 136 | 21.4 |
| Small Tuff + Peat | 619 | 1054 | 435 | 70.3 |
| Large Leca + Peat | 485 | 736 | 251 | 51.8 |
| Large Leca | 456 | 494 | 38 | 8.3 |
| Large Leca + Perlite | 414 | 549 | 135 | 32.6 |
| Small Leca | 305 | 395 | 90 | 29.5 |
| Small Leca + Perlite | 289 | 440 | 151 | 52.2 |
| Small Leca + Peat | 281 | 533 | 252 | 89.7 |
| Perlite + Peat | 231 | 656 | 425 | 184.0 |

particles having a size of about 10-20 mm and has a depth of about 3 cm, whereas the second tier 26, laid on top of the first, has a depth of about 4 cm and consists of particles of a size up to 4 mm. The bottom tier has a density of 850-950 grams per liter and the top tier has a density of 1300-1400 grams per liter. If the porous material is perlite, then the depth of the tiers is the same as in the case of tuff, but the bottom tier is made of particles having a size of about 0.4 mm, its density being about 10 grams per liter; and the top tier is made of particles having a size of about 0.2 mm, its density being of 5 gm per liter. It should be understood, however, that the above figures constitute only an example and are not limitative in any way.

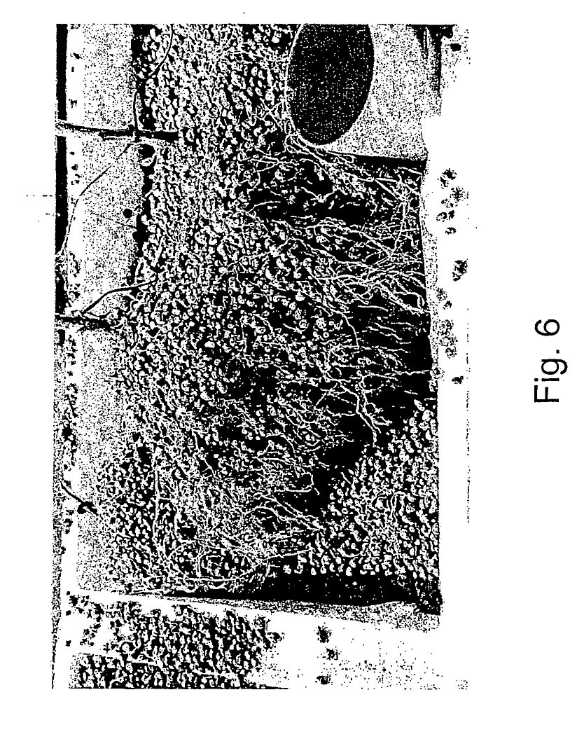

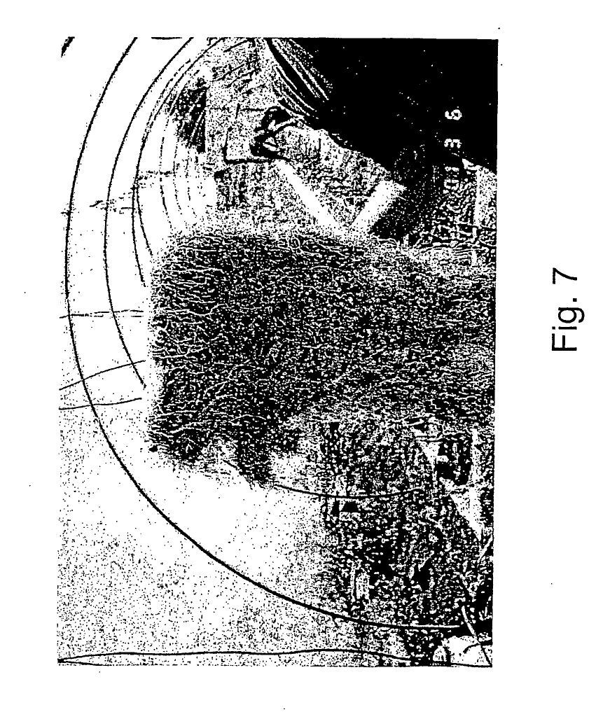

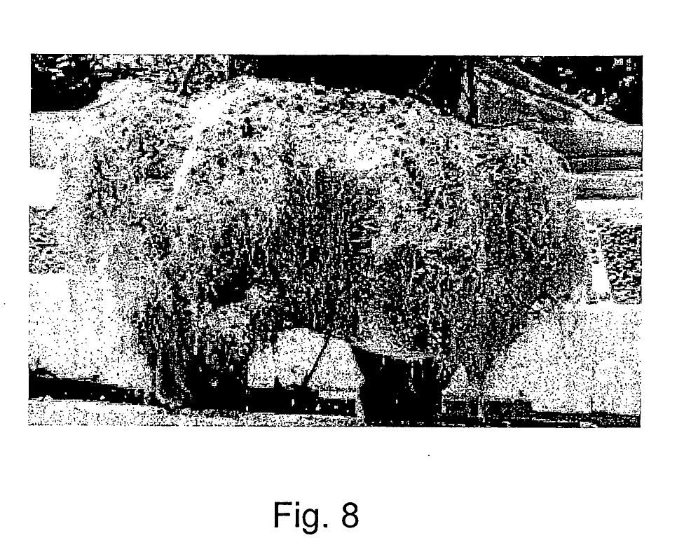

Seedlings 11 are planted within each container 21. Conduit 5 may be imbedded slightly below particulate material surface 6 so as to provide adequate irrigation to the small-sized roots. The water which is not taken by seedling 11 collects on container bottom 22, and if the collected water attains a level which is higher than a predetermined value, is drained through orifices 23, when more than one orifice is used. As a result of the drainage of water through orifices 23, particulate material 7 is functionally divided into two layers: a saturated layer below the orifices where a body of water collects, and a relatively dry layer above the orifices. As the plant matures during a period of approximately 14 days, the primary root branches into additional secondary roots, the extremities of which develop root hairs, and extends into and is entwined with the saturated layer, from which the roots absorb water and inorganic nutrients. In contrast with conventional root development whereby roots downwardly extend and develop in search for an adequate supply of water needed for rapidly maturing plant, the roots which develop with the use of the present invention do not have to downwardly extend due to the readily available supply of water. Since the roots are in an optimal balance between water and oxygen intake, due to the fact that the root hairs are constantly saturated with water, there is no need for the roots to downwardly develop, and as a result the downward growth of the roots is inhibited. The roots, however, develop laterally and are interspersed with the entire volume of the porous bed and entwined with the particulate material, to form a thick mass. FIG. 6 is a picture of the roots of a mature plant grown with the use of the present invention that are interspersed with particulate material. FIG. 7 shows the roots when they are removed from the container in which they were grown. FIG. 8 illustrates the root formation after the particulate material is removed therefrom, which is sufficiently structurally strong so as to allow the plant shoot to be held without detachment from the roots.

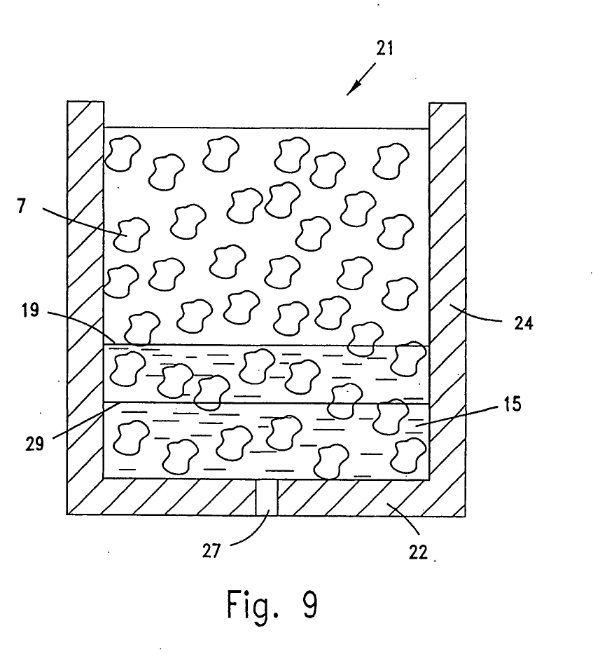

FIG. 9 illustrates the placement of a porous bed in respect to body of water 15, which assumes a level 19 throughout container 21. Particulate material 7 may be placed in position before opening the shutoff valve to allow water to enter the container, or alternatively, the porous bed may be placed in position after the body of water 15 has already formed. After a period of time, the water is either absorbed by the particulate material or permeates through the porous bed. The water level, instead of being at level 19, is lowered within container 21 to attain level 29, without the influx of additional water. The difference between water levels 19 and 29 is dependent upon the WHC of the particulate material placed in container 21, the ambient temperature and the type of plant grown. Water evaporation is minimized due to the influence of the upper aerated and relatively dry layer of particulate material.

After a short period of time, the water level within container 21 stabilizes and reaches a uniform level that is to be controlled, e.g. 3.5 cm for vegetables. If the water level is lower than this value, the water evaporates and the growth of the vegetables is stunted, whereas if the water level is higher than this level the roots begin to decompose due to flooding and air depletion of the root system, and at another level, e.g. of approximately 5 cm for vegetables, the plant decays. Accordingly, if lower water level 29 is below a predetermined level, float switch 13 (FIG. 4) will induce a warning signal. Valve 1 may then be opened to admit an additional amount of water into the container, thereby raising the water level 19 of each individual container, until a predetermined uniform level is attained. The frequency of water refill into each container is dependent on the ambient temperature and humidity, intensity of solar radiation, and the mass of the plant foliage, which affect transpiration and evaporation.

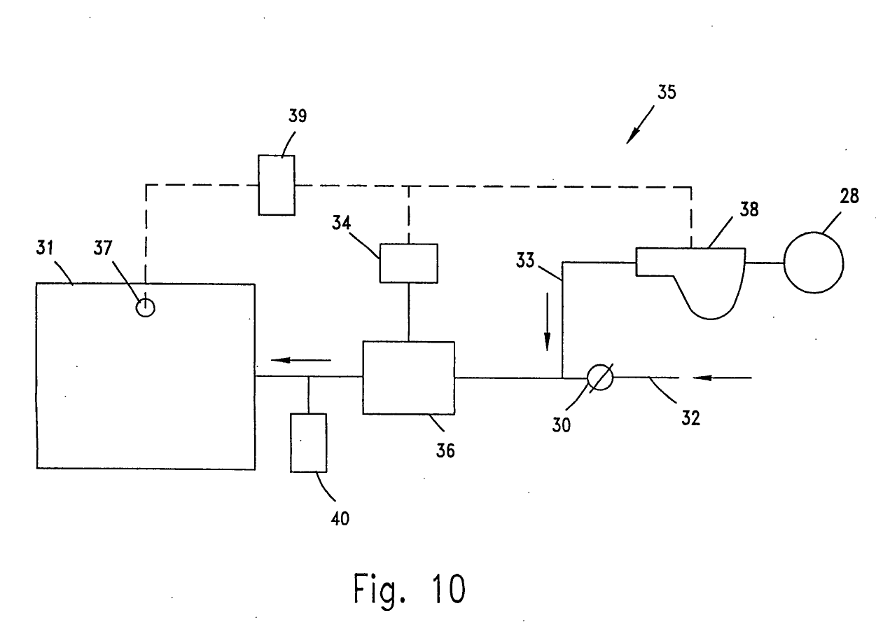

Another preferred embodiment of the water management system is illustrated in FIG. 10. Water level regulation unit 35 includes control valve 36 and singular sensor 37, which is operative to sense the water level within a container 31. It should be appreciated that the water level as sensed by sensor 37 is a sampling of the water level of all of the containers 31. Water flows into water line 32, after shutoff valve 30 has been opened, through control valve 36, when the control conditions enable such a flow as detailed hereinafter, and is injected into at least one container 31, either in series or in parallel, in the manner as described in reference with FIGS. 1 and 3, respectively. Fertilizer 28 is added, through secondary line 33, by means of fertilization pump 38 into water line 32. By example, a type of fertilizer that is suitable for vegetable growth is Sheffer 3, for winter growth, and Sheffer 666 (for seedlings) and Sheffer 1(587) for summer growth, all produced by Deshanim Inc., Israel. Sensor 37, which is for example a discrete level switch or an interphase sensor (monitors the transition between the two phases of water and air), detects the water level within a container and communicates with controller 39. Controller 39 in turn communicates with control valve actuator 34, e.g. a solenoid actuator, and with fertilization pump 38. When the water level falls below a predetermined low switch point, controller commands control valve 36 by means of actuator 34 to allow water inflow. Similarly when the water level rises above a predetermined high switch point, control valve 36 is commanded to prevent water inflow into water level regulation unit 35. Since the Israeli Professional Agricultural Instruction Services recommends that a concentration of fertilizer ranging from 1.2-1.7 liter per 1000 m³ of water be used, depending on the crop and climate, controller 39 commands fertlization pump 38 to deliver a certain flow rate of fertilizer for a specific duration to water line 32 so that the predetermined fertilizer concentration is achieved. Accordingly, a reduction in water usage necessarily results in a reduction in fertilizer usage, in contrast to prior art agricultural water management systems. Consequently any reference hereinafter to water savings implicitly refers to savings in fertilizer as well. The switch points are selected to ensure that an optimal water level is maintained throughout all of the containers 31.

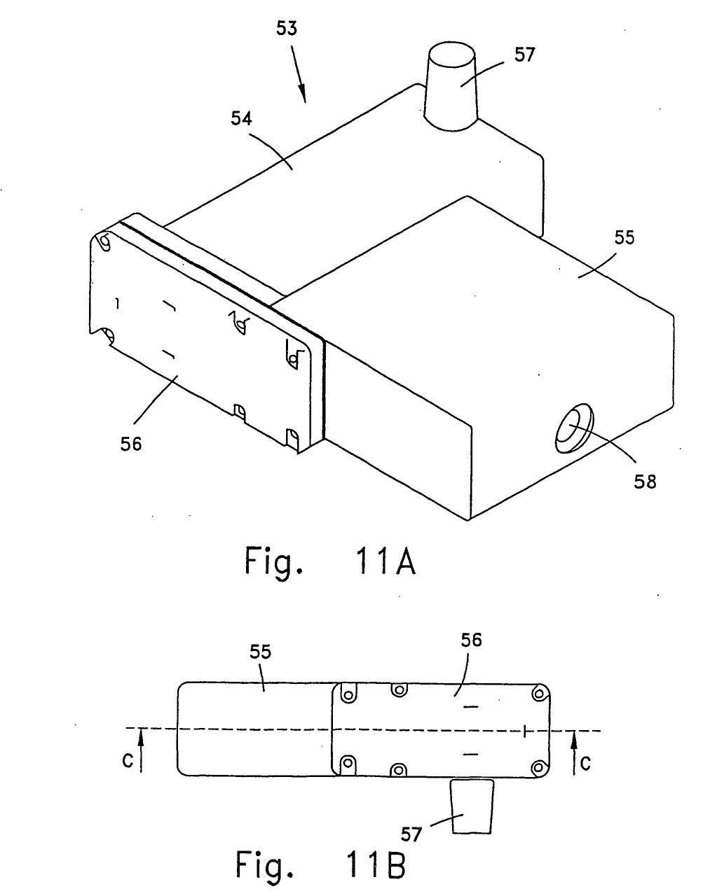

Another exemplary sensor is illustrated in FIGS. 11-14. A capacitive transduction sensor, indicated generally by numeral 53, is shown in FIG. 11A, and a top view is shown in FIG. 11B. Sensor 53 is provided with electrode housing 54, housing 55 of the control and measurement circuitry card, cover 56, water column inlet 57 disposed at the bottom of electrode housing 54, and cable connection 58. Electrode housing 54, circuitry housing 55 and water column inlet 57 are manufactured as one integral unit, and are produced from a rigid plastic such as polyurethane, nylon 66, or any other type well known to those skilled in the art.

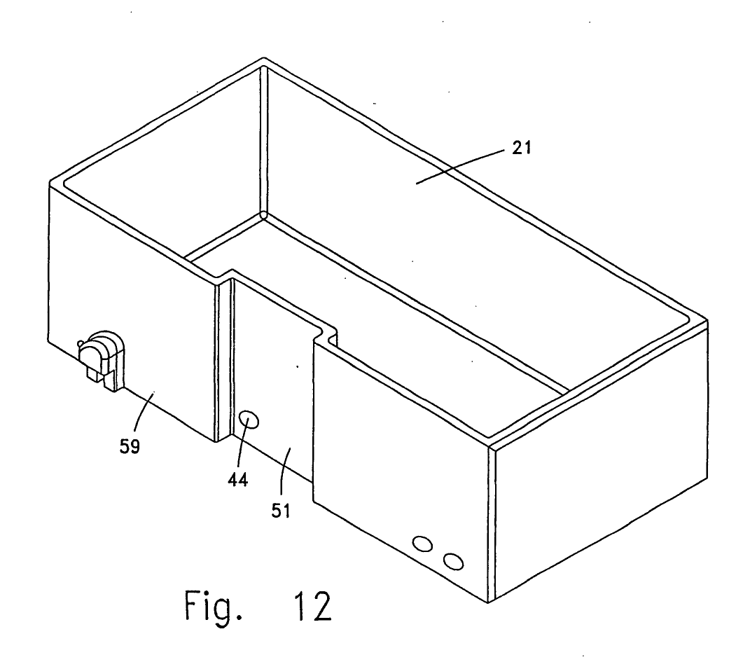

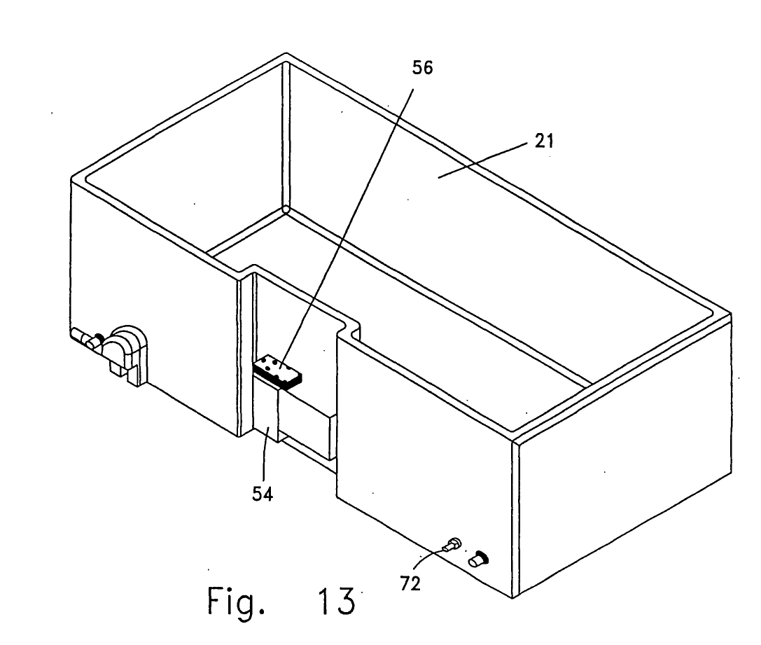

With reference now to FIG. 12, container 21 is adapted to receive a capacitive transduction sensor within portion 51, which is recessed from front wall 59 of the container. Portion 51 is formed with aperture 44, into which water column inlet 57 is insertable. Water column inlet 57 (FIG. 11A) is provided with a conically shaped outer wall, tapering to a smaller diameter at a distance from electrode housing 54, and a tube (not shown) parallel to the axis of inlet 57 for the flow of water therethrough. Accordingly, water column inlet 57 is engaged with aperture 44 by a pressure fit, and sensor 53 is thereby mounted to container 21, such that electrode housing 54 is vertically disposed and covered by cover 56 located thereabove, as shown in FIG. 13.

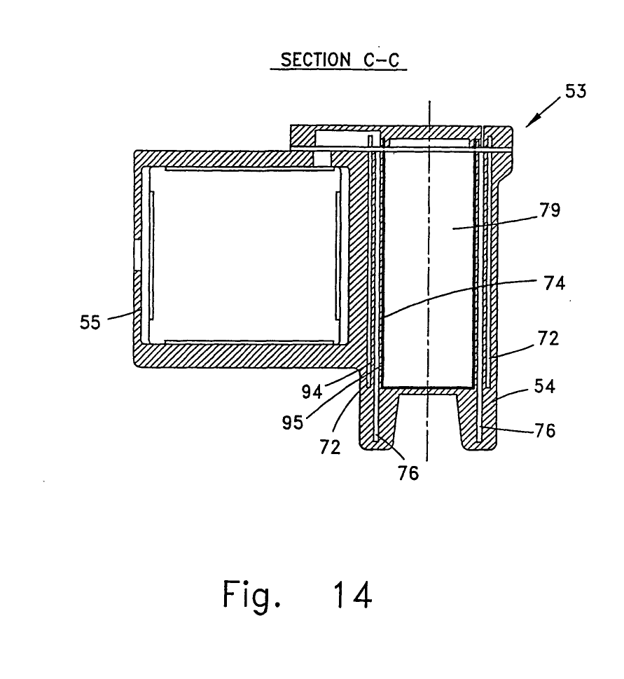

FIG. 14 is a longitudinal cross sectional view of sensor 53. Electrode housing 54 is provided with cavity 79 into which rectangular inner electrode 74 is placed. Electrode housing 54 is also provided with two box-like grooves, e.g. having a thickness of 2 mm, which surround inner electrode 74. Groove 76, e.g. having a thickness of 3 mm, is adapted for the introduction therein of water from water column inlet 57 (FIG. 11A), and extends substantially from the bottom of electrode housing 54. The second groove surrounds groove 76, and outer electrode 72 is placed within the second groove. Electrodes 72 and 74, which are preferably made of copper, and groove 76 are bottomless, and consequently may surround one the other without any physical interference. Partition 94 separates outer electrode 72 from groove 76, and partition 95 separates groove 76 from inner electrode 74. Partitions 94 and 95 are integrally formed with electrode housing 54.

As water is introduced to container inlet 72 (FIG. 13) and achieves a predetermined height within container 21, water is admitted to groove 76 via water column inlet 57 (FIG. 11A). The water admitted to groove 76 is essentially a water column and the height of which corresponds to the water level within container 21 (FIG. 13). The water column is therefore variable and indicates the instantaneous water level within the container. As previously mentioned, sensor 53 is of the capacitive transduction type, and is adapted to determine a change in height of the water column by measuring the change in the dielectric constant between outer electrode 72 and inner electrode 74. When sensor 53 is powered, e.g. by DC excitation having a voltage of 12 V, the capacitance between electrodes 72 and 74 can be measured. The dielectic constant between electrodes 72 and 74 is dependent on the fixed value of partitions 94 and 95, and on the variable value of the water column. The gap between partitions 94 and 95 is filled with air at that height above the bottom of groove 76 under which the top of the water column is located.

The control and measurement circuitry card contained within housing 55 measures the instantaneous capacitance, which is directly proportional to an output voltage. As the water column achieves a predetermined level, e.g. 3 mm, the control and measurement circuitry card identifies a change in output voltage above a predetermined threshold and generates a signal which commands control valve 36 (FIG. 10) to close. Similarly, a reduction in capacitance follows a reduction in the level of the water column. When the output voltage falls below a predetermined threshold, a signal is generated to open the control valve. The capacitance of sensor ranges, by example, from 28-60 pF for a range in depth of the controllable layer of water within the container of 2,5-3.5 cm.

It will be appreciated that sensor 53 has no moving parts and additionally, there is no direct contact between water and the electrodes. Consequently, sensor 53 is particularly suitable for an agricultural environment in which dirt carried by the water whose level is to be measured generally accumulates on the moving parts of a float switch and hampers the effectiveness of the sensor. Also the presence of moisture, light and a difference in potential cause a build-up of corrosion on the electrodes of a conventional capacitive transduction sensor, as well as a generation of fungus within the liquid whose depth is to be measured. Sensor 53 essentially obviates the build-up of corrosion on electrodes 72 and 74 since there is no direct contact between the water column and the electrodes.

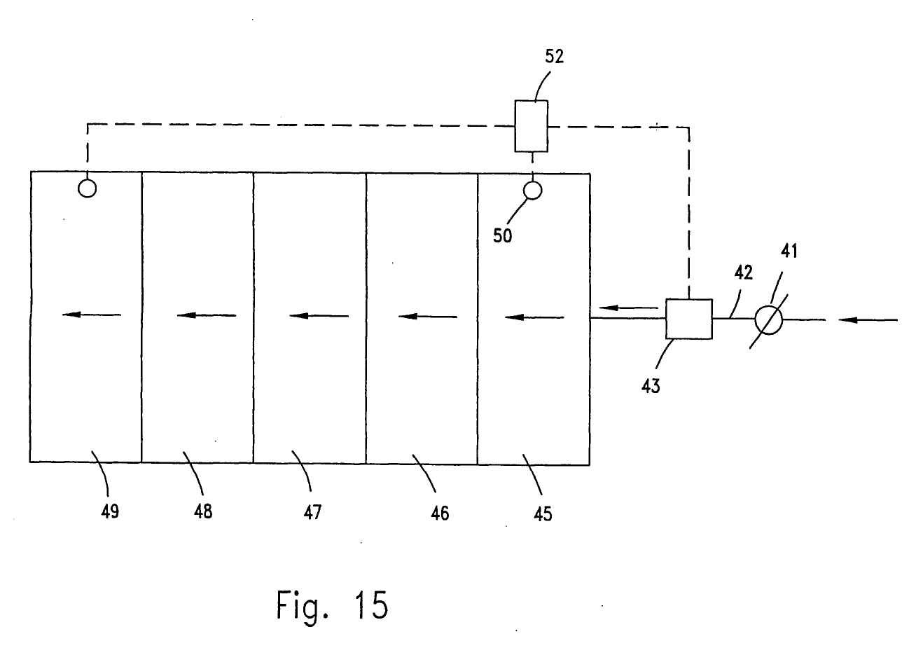

Another embodiment of the water management system is schematically illustrated in FIG. 15, in which a plurality of sensors 50 are employed. As shutoff valve 41 is opened, water flows through pipe 42, through control valve 43 and then into a set of containers. By way of example five containers 45-49 are illustrated, but any other number of containers may be utilized. Each container is placed in juxtaposition with one another, in series. As said, containers can also be spaced apart from one another, and the water supply is then effected via a suitable piping system.

Sensors 50 are disposed, by example, in containers 45 and 49, and detect the water level in the corresponding container. Each sensor may be a float switch, an interphase sensor, in which case it monitors the transition between the two phases of water and particulate material, a soil moisture sensor, in which case it monitors the moisture content absorbed by the porous bed, a capacitive transduction sensor, or any other suitable sensor. If a sensor other than a direct level gauge, such as a float switch, is employed, a correlation is made between the sensed value and a level of water within the appropriate container. The sensed value in each container may be different. To determine the need for additional water, a sensor is located, e.g., in the container disposed the closest and furthermost from control valve 43, which in the example of FIG. 15 are containers 45 and 49. Similarly the set points and the sensitivity of the sensor may be determined in accordance with the water usage of the particular vegetable growth being cultivated in the corresponding container. For example, the sensitivity of the sensor may be advantageously selected such that the rate of water influx into the corresponding container is substantially equal to the rate of water level decrease. For example, each tomato plant requires 1.5 liter/day of water. If the container has a depth of 20 cm and a surface area of 1.5 m², an optimal water level is a depth of 3.5 cm. The sensor transmits a signal if the water level is below the set point of 3.4.cm. The control valve then opens to allow a flow rate of 2 liter/hr through a hose having 22 perforations per container for a duration of 8 seconds, such that each plant receives sufficient irrigation from two perforations. Water is drained through an orifice if the water level is above 3.6 cm. Controller 52 acquires the data input from each sensor, compares the relative values, processes the information, and commands the actuator of control valve 43 to regulate the inflow into containers 45-49.

The construction of controller 52 is of course dependent upon the particular type of sensor used, as will be apparent to the skilled person. The controller, in a particular embodiment of the invention, comprises four sub-units: a microprocessor, software for programming the actuator in a preferred manner (which may, of course, be implemented by hardware), a local memory and a means of communicating with the control valve actuator and sensors. These sub-units will also be easily apparent to the skilled person, and are therefore not described herein in detail, for the sake of brevity.

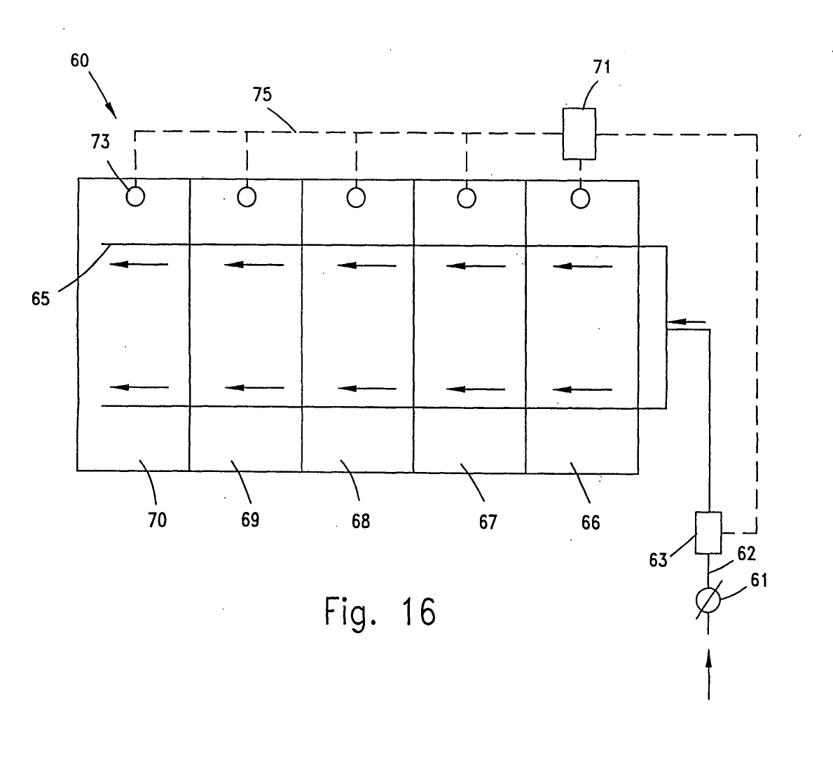

As is well known, a control valve is actuatable to admit a predetermined amount of water at a predetermined flow rate. The embodiments of FIGS. 10 and 15 are accordingly suitable for all types of irrigation, such as sprinkler irrigation, drip irrigation and underground irrigation. As a non-limitative example, FIG. 16 illustrates a water management system 60, an embodiment of the present invention for the application of drip irrigation in which a control valve is actuated in response to signals transmitted by sensors. As shutoff valve 61 is opened, water flows through pipe 62, through control valve 63 and then into flexible hose 65, to which a number of drip emitters are secured so that a small amount of water continuously drips at specified locations in close proximity to the roots of the plants growing within containers 66-70. Flexible hose 65 passes from one container to another. Two rows of flexible hoses 65 are shown, but any number of rows may be employed to provide an adequate supply of water to all of the plants grown in the containers, e.g. such that water drips from 22 holes per container. Similarly the flexible hose may be laid in any configuration within the set of containers, such as serpentine or curvilinear. The flexible hose may be laid on the upper surface of the porous bed, or may be imbedded therein, at a location such that the growth of the plants being cultivated within the containers is not impeded, e.g. 7 cm below the surface layer of the particulate material. Controller 71 receives input from sensors 73, one of which is located in a corresponding container 66-70, via cable 75, or alternatively in wireless fashion, and in accordance with a predetermined program, and commands the control valve actuator to deliver water at a preferred pressure and flow rate and for a predetermined duration, depending on the input signals from sensors 73, so that the water level within the containers will not fall below a predetermined value. The water which drips from the emitters is directed at the roots of the vegetable growth, or at any other convenient location, and any excess water not absorbed by the roots or by the particulate material is accumulated along the bottom of each container. Some of this water evaporates or permeates to the upper layer. After the particulate material is completely saturated, the water which is not absorbed by the roots of the vegetable growth will descend to the bottom of the corresponding container. The water at the bottom of each container, after a short period of time, reaches a uniform level that is to be controlled, as described hereinabove, in order to provide optimal growing conditions and efficient usage of water.

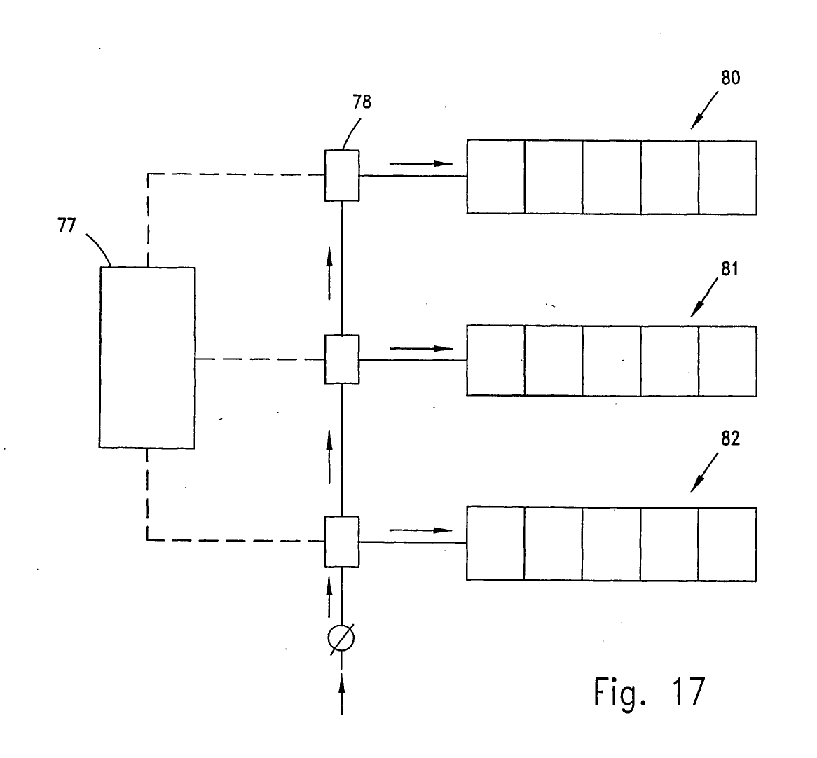

FIG. 17 illustrates another preferred embodiment in which controller 77 controls the actuation of a plurality of control valves 78. Each control valve 78 admits the inflow of water into the corresponding set of containers 80, 81 and 82. The sensors of each set of containers communicate with controller 77, which determines, as a result of a selected program, whether the water level is above a predetermined value, and if not, initiates a command to the corresponding control valve actuator to admit an additional amount of water. Preferably each control valve 78 admits water to the corresponding set of containers at a different time, so that water at the optimal flow rate and pressure will be admitted thereto. If extenuating circumstances dictate that water has to be admitted to several sets of containers simultaneously, controller 77 commands the actuators to approximate the preferred operating conditions as much as possible.

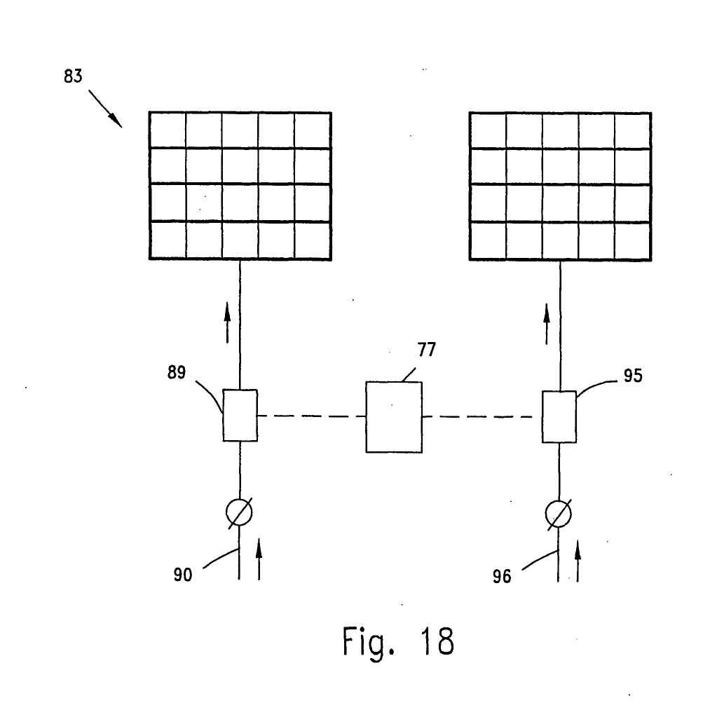

FIG. 18 illustrates another embodiment wherein a controller commands the actuation of two separate control valves 89 and 95, through which water flows from two separate water lines 90 and 96, respectively. With this configuration the water flow rate and pressure is sufficient to maintain the water level for sectors of containers 83. Each sector is comprised, for example, of four sets of containers, each of which is provided with five containers.

As has been said, the level of the drainage orifices divides the particulate material into two layers, a lower one saturated with liquid and a relatively dry upper one (as hereinbefore defined). When two (or more) tiers of different particulate material are provided, the tiers may coincide with said two layers according to whether the drainage orifices are placed at the level between the two tiers or at a different level. Therefore it should be understood that the distinction between “tiers” is based on the particulate material of which they consist (and if only one material is used, there is only one tier) while the distinction between “layers” is based on the presence or absence of liquid in the spaces defined between particles of the particulate material, and therefore on the level of the drainage orifices. Once again, it should be noted that moisture can be present also in drained layers of particulate material, as explained hereinbefore.

When the particulate material is capillaric, chlorides permeate the material and accumulate at the top of the upper tier. Under normal circumstances, the particulate material needs to be replaced at the end of the growing season, or alternatively, needs to be thoroughly washed, in order to remove the high concentration of chlorides that has accumulated. It has been surprisingly found, that a lower tier of capillaric particulate material may be reused for many growing seasons when an upper tier of a different type of capillaric material, such as perlite, is employed.

This upper tier is located above the saturated layer of particulate material to ensure that it remains external to the biomass formed by the root hairs extending through the saturated layer and to allow for its removal. This upper tier preferably has a relatively low density, so that it is relatively easily removable after adsorption of the chlorides that have permeated upwards. At times the water and chlorides that have permeated solidify, and form an aggregate together with perlite particles. Such an aggregate is visible, and the removal of the chlorides is then additionally simplified. Any other capillaric particulate material may be used for the adsorption and later removal of chlorides, in addition to perlite, as long as said particulate material is conducive to the growth of plants therein. Such material preferably, but non-limitatively, has an apparent density ranging from 40 to 170 kg/m³, and more preferably less than 80 kg/m³ and has a water adsorption of at least about 200% by weight. The upper tier may be easily removed by a hand held implement.

Each container wall 24 of the container 21 is provided with at least one orifice 23 (FIG. 4) for the drainage of water, while a larger number of orifices allows for a greater rate of drainage from the container. Each orifice is disposed at a height that depends on a preferred maximum water level within the container. Orifices 23 pass through container walls 24 and allow for the horizontal discharge of water. The dimensions of the orifices and their placement within the container should be such as to guarantee an adequate drainage. A retaining means, such as a screen or a water resistant fabric, can be placed within the container over the orifices to prevent loss of perlite through the drainage orifices and/or clogging of said orifices by the perlite. A mesh of water-resistant fabric may also be placed within the said top layer of particulate material, or immediately above it. A second set of “normally closed” drainage orifices 27 (FIG. 9) is provided on the container bottom 22 to allow for complete drainage of body of water 15, if so desired.

By way of example, and for this purpose, the diameter of the drainage orifices may be from 5 to 20 cm, and the distance between two successive orifices may be such as to provide, for example, 2 openings per 2.5 m² of container, or thereabout. They are placed at a height of a few centimeters, preferably from 1 to 7 cm, and preferably for many applications, about 4 cm, from the bottom of the container, creating a lower porous layer, having a depth equal to said height, which is filled with water or aqueous solution up to that level, and above it, an upper liquid-free, porous layer, preferably having a depth from 5 to 12 cm or more, depending on the height of the bordering material (and which, as explained above, is not necessarily free from moisture, but does not contain a layer of water). The apparatus of the invention therefore provides a means for maintaining the level of water that permeates from the porous bed to the vegetable growth to be above and below predetermined levels, respectively.

As shown in FIG. 4, drainage unit 27 may be provided with container 21 such that the drainage of water from container 21 passes therethrough. Drainage unit 27 consists of a short cylindrical conduit that terminates with a nozzle. Drainage unit 27 is insertable through orifice 23 by means of a stem having a rotatable element whereby at one rotational position drainage is possible, at a second rotational position drainage from the container is prevented and at an intermediate position partial drainage is effected. By allowing drainage unit 27 to be in an intermediate position, the water will not be completely drained at the set point, i.e. at the predetermined water level that would be attained if the drainage unit were completely open. That is to say that a container provided with such a drainage unit is capable of cultivating, at different times, several types of plant growth, each of which requires a different water level. A drainage unit 27 may be positioned at the bottom of container wall 24 to allow for complete drainage of container 21

Preferably, the vegetable growth should be able to be grown throughout the different seasons, e.g., summer, by which the warmer months are generally designated, and winter, by which cold months are generally designated. The roots of the carpet growth should be kept at an optimal temperature, generally in the range of 18° C. to 22° C. In winter, the water discharged from water level regulation unit 5 must be heated to obtain satisfactory rersults. For this purpose, as shown schematically in FIG. 10, a heater 40 is provided, which heats the inlet water flowing through main 32 to container 31. This heater may be manually operated or may be automatically controlled in response to input from a temperature detector (not shown).

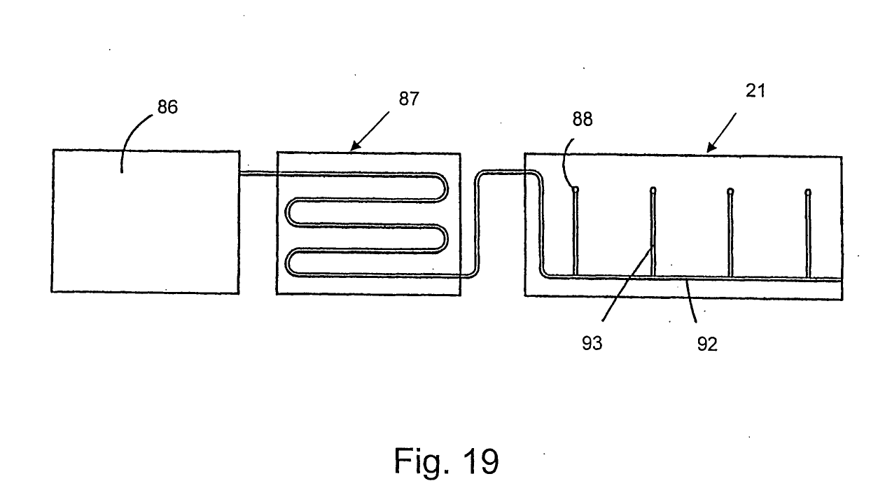

A second preferred embodiment of the heating system is illustrated in FIG. 19. A heater 86, heat exchanger 87 and a pipe system, comprising for instance polyethylene pipes having a diameter of 12-16 mm, are provided within container 21. For example, the system may have, as in this embodiment, a comb-like structure, comprising a manifold 92 and a number of derivations 93, each leading to an underground aperture or nozzle, schematically indicated at 88. Water from the heat exchanger is caused to flow through said pipe system, and provides the desired heat to the underside of the vegetable growth carpet.

The containers can be placed on any flat surface, whether artificially prepared, e.g. the flooring of a greenhouse, or naturally occurring. The properties of carpets, particularly when grass is grown with the use of the present invention, are important in facilitating maintenance of the building surfaces on which they are laid. For instance, if the bottom of the container or containers is constituted by an area of a building surface, and if said surface requires, for instance, renewed or improved waterproofing, it is sufficient to roll the carpet to expose the said area, to carry out the desired maintenance operation (e.g., cleaning it and then applying to it a fresh layer of asphalt or tar) and then unroll the carpet back to its original position.

Chlorine Experiments

### EXAMPLE 1

Tables II-IV below detail a water count of the controllable layer of water which is absorbed by the plants grown with an implementation of the present invention, measured in ppm.

The following tables reflect a water count of a controllable layer of water after 6 months of growing plants within the corresponding container, without any rinsing or complete drainage of the water. It should be appreciated that in prior art systems a container is rinsed at least once a week, and usually once a day. The water count shown in Tables II-IV was taken on May 5, 2001, May 24, 2001 and on Jun. 1, 2001, respectively. Each upper table indicates the water count for tap water and for the drip irrigation water admitted into a container, while each lower table indicates the water count of the controllable layer of water. The following parameters were measured: conductivity (EC), acidity (pH), nitrites (N—N0₂), nitrates (N—NO₃) and chlorides (Cl), for different types of bedding and for different types of crops. EC is dependent on Cl, and is low when the chloride level is low as well. Certain crops such as strawberries are sensitive to an increase of over 60 ppm of chlorides, and as a result a suitable type of bedding, such as large tuff and peat, needs to be selected. According to the Israeli Department of Agriculture, water having an absolute chloride level of up to 600 ppm is suitable for growing tomatoes, and therefore any of the types of bedding enumerated in the tables may be used. A crop designation of “C” indicates that cucumbers were grown and a designation of “T” indicates that tomatoes were grown in the corresponding substrate. The ratio of particulate material, when relevant, is 1:1, v:v. The same experimental conditions as those specified in relation to Experiment 4 below were used, namely the same types of crops were grown with the same crop density, the area of each container is 0.5 m², the depth of each container is 20 cm and the depth of the controllable layer of water is 3.5 cm. Water was initially admitted to the containers on May 12, 2001. For the first two weeks of experimentation, the type of fertilizer was Sheffer 666, and afterwards Sheffer 1 was used.

### EXAMPLE 2

For the next set of experiments, tomato plants were grown in a net-house of 50 mesh during the period of April-August, 2001 at the Agricultural Farm of Bar-Ilan University, located 10 km east of Tel-Aviv. The plants were grown in 100-liter non-drained containers having a controllable water layer of 3 cm, in accordance with the present invention, wherein each container was filled with one of the following seven substrates: large leca, tuff, tuff and perlite (1:1, v:v), tuff and peat (1:1, v:v), leca and peat (1:1, v:v), leca and perlite (1:1, v:v), and peat and perlite (1:1, v:v). The same experimental conditions as those specified in relation to Experiment 5 below were used, namely with the same crop density. For the first two weeks of experimentation, the type of fertilizer was Sheffer 666, and afterwards Sheffer 1 was used.

TABLE II
(17/5/2001)

| | EC | pH | N—NO₂ | N—NO₃ | Cl |
|---|---|---|---|---|---|
| Tap Water | 0.8 | 8.0 | 0 | 9 | 180 |
| Drip irrigation water | 1.4 | 7.0 | 0 | 53.63 | 180 |

| Type of bedding | Crop | EC | pH | N—NO₂ | N—NO₃ | Cl |
|---|---|---|---|---|---|---|
| Large Leca | C | 1.7 | 8.0 | 0 | 8.64 | 320 |
| Large Tuff + peat | C | 0.9 | 7.5 | 0 | 1.6 | 225 |
| Large Tuff + Perlite | C | 1.1 | 7.0 | 0 | 72.72 | 160 |
| Large Tuff | C | 1.1 | 8.0 | 0 | 38.18 | 180 |
| Peat + Perlite | C | 0.8 | 7.0 | 2 | 24 | 150 |
| Large Tuff + peat | T | 1.0 | 7.5 | 2 | 24.54 | 200 |
| Large Tuff + perlite | T | 1.1 | 7.0 | 5 | 80 | 160 |
| Large Tuff | T | 0.8 | 8.0 | 2 | 2.04 | 190 |

TABLE III
(24/5/2001)

| | EC | pH | N—NO₂ | N—NO₃ | Cl |
|---|---|---|---|---|---|
| Tap Water | 0.8 | 7.5 | 0 | 13.4 | 195 |
| Drip irrigation water | 1.4 | 7.2 | 0 | | |

| Type of bedding | Crop | EC | pH | N—NO₂ | N—NO₃ | Cl |
|---|---|---|---|---|---|---|
| Large Leca + Perlite | C | 1.2 | 6.0 | 0 | 66.36 | 175 |
| Large Leca + Peat | C | 1.3 | 6.0 | 0 | 3.63 | 330 |
| Large Tuff + Peat | C | 1.0 | 7.0 | 0 | 1.59 | 225 |
| Large Tuff + Perlite | C | 1.2 | 8.0 | 0 | 75.45 | 175 |
| Large Tuff | C | 1.2 | 7.0 | 5 | 50.90 | 200 |
| Peat + Perlite | C | 1.0 | 6.0 | 0 | 20.22 | 190 |
| Small Leca + Perlite | T | 1.2 | 7.0 | 2 | 8.86 | 250 |
| Peat + Perlite | T | 1.5 | 6.0 | 0 | 50.90 | 300 |
| | | 1.1 | 6.0 | 0 | 42.72 | 250 |
| Large Tuff + Peat | T | 1.1 | 7.0 | 5 | 32.72 | 210 |
| Large Tuff + Perlite | T | 1.3 | 6.5 | 5 | 89 | 175 |
| Large Leca + Peat | T | 1.6 | 5.5 | 0 | 2.72 | |
| Large Tuff | T | 1.0 | 7.0 | 0 | 10.45 | 225 |

TABLE IV
(1/6/2001)

| | EC | pH | N—NO₂ | N—NO₃ | Cl |
|---|---|---|---|---|---|
| Tap Water | 1.2 | 7.5 | 0 | 0 | 275 |
| Drip irrigation water | 1.4 | 7.2 | 0 | 1 | |

| Type of bedding | Crop | EC | pH | N—NO₂ | N—NO₃ | Cl |
|---|---|---|---|---|---|---|
| Large Leca + Perlite | C | 1.4 | 6.0 | 0 | 55.9 | 260 |
| Large Leca + Peat | C | 1.3 | 7.0 | 0 | | 320 |
| Large Tuff + Peat | C | 1.3 | 7.0 | 0 | 0 | 280 |
| Large Tuff + Perlite | C | 1.4 | 7.0 | 0 | 70.90 | 250 |
| Small Leca + Perlite | C | 1.4 | 6.5 | 0 | 41.81 | 250 |
| Peat + Perlite | C | 1.3 | 7.0 | 0 | 20.0 | 200 |
| Peat + Perlite | T | 1.4 | 6.5 | 0 | 41.36 | 275 |
| Large Tuff + Peat | T | 1.4 | 7.0 | 5 | 37.27 | 300 |
| Large Tuff + Perlite | T | 1.5 | 7.0 | 2 | 81.81 | 250 |
| Large Leca + Peat | T | 2.0 | 5.5 | 0 | 1.36 | 500 |

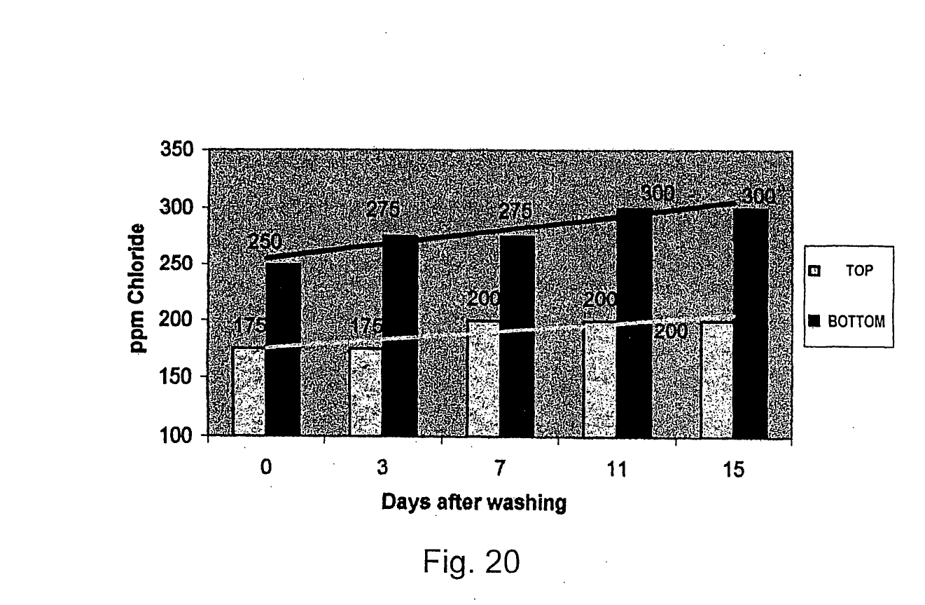

FIGS. 20-26 indicate the amount of chloride accumulation within each of the aforementioned substrates over a period of time. Before conducting the experiment, all of the substrates were thoroughly washed, and the chloride level was measured. The chloride level was then measured on the third, seventh, eleventh, and fifteenth day following the initial washing. For these experiments, the chloride level was measured at a location corresponding to 7 cm below the upper surface of a substrate, herein referred to as “top,” and within the controllable layer of water, herein referred to as “bottom.”

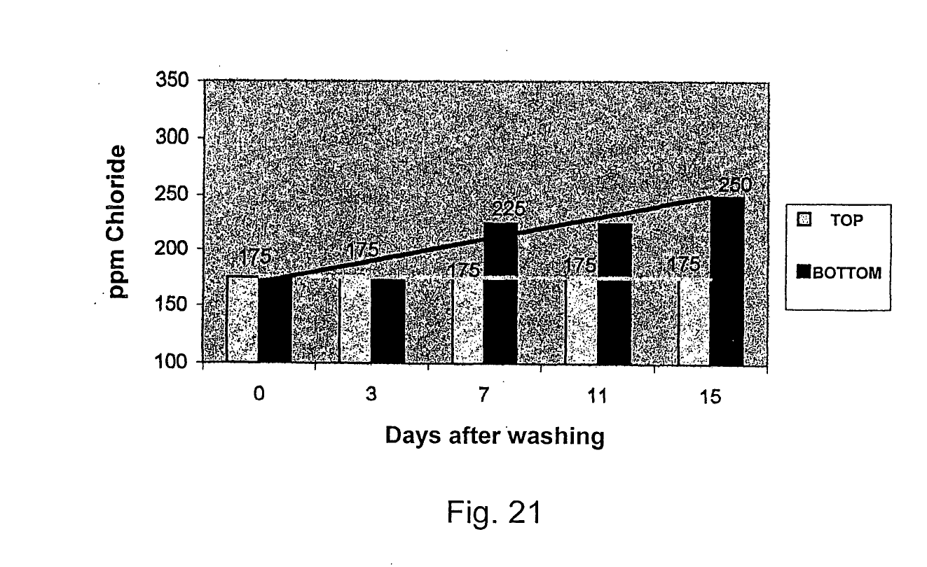

For the non-capillaric substrates of leca and tuff, as shown in FIGS. 20 and 21, respectively, an increasing chloride concentration at the bottom was revealed. For leca, there was an increase of 25%, from 250 to 300 ppm, and for tuff, there was an increase of 43%, from 175 to 250 ppm. In contrast, there was substantially no increase in the chloride concentration at the top. For leca, there was increase of 14%, from 175 to 200 ppm, and for tuff there was an increase of 0%, remaining at 175 ppm.

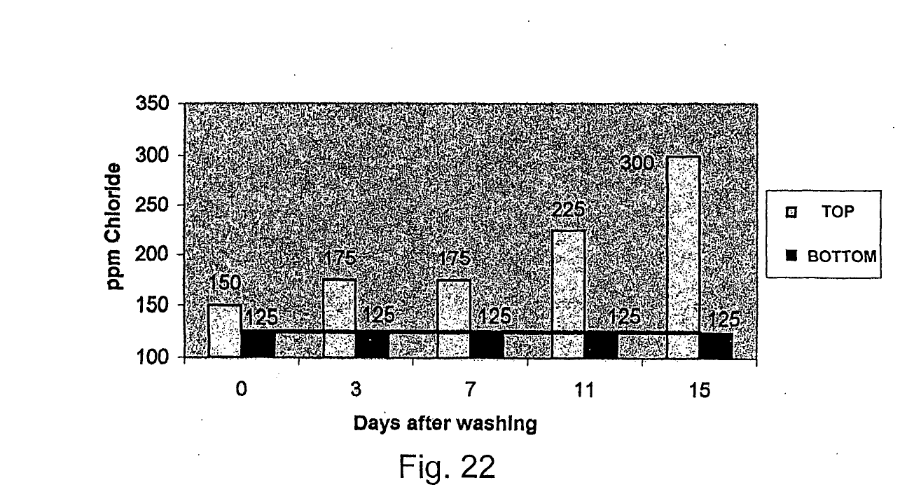

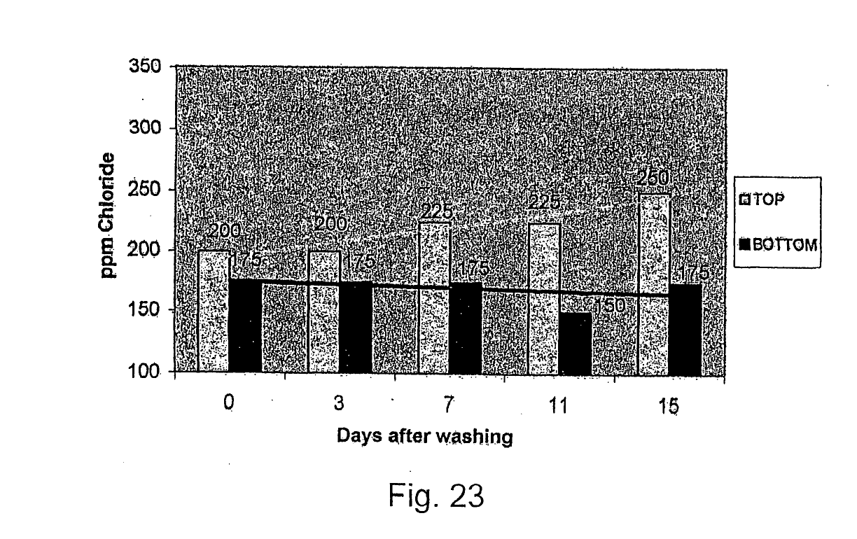

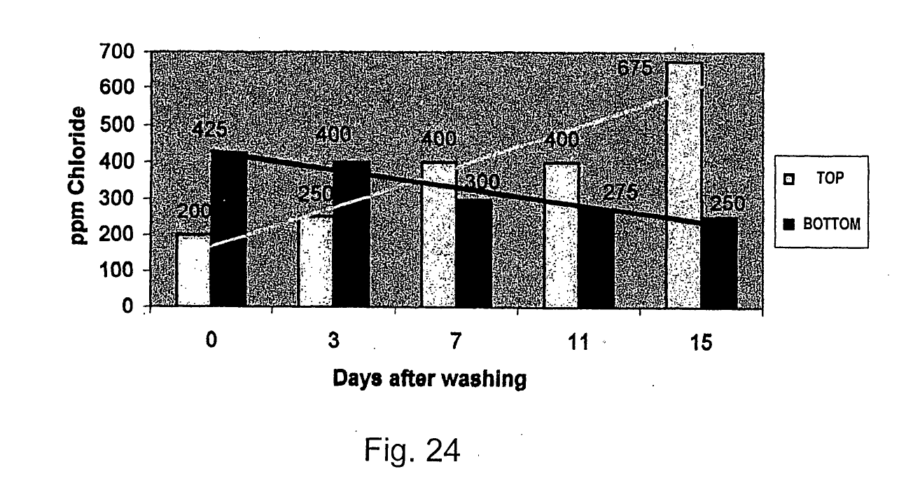

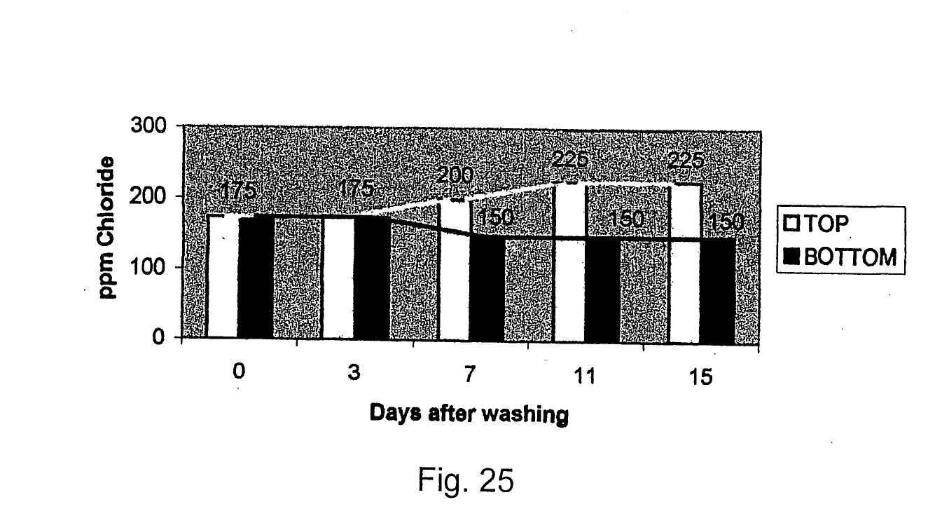

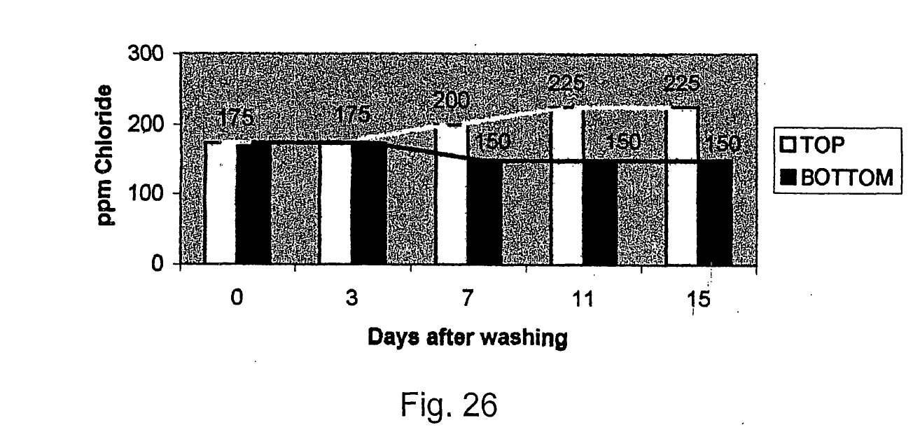

A different tendency was revealed with respect to capillaric substrates. In FIG. 22, there was a gradual increase of 100% at the top, in contrast to a 0% increase at the bottom. In FIG. 23, there was a 25% increase at the top and a 0% increase at the bottom. In FIG. 24, there was an increase of 338% at the top and a decrease of 41% at the bottom, having an initial high chloride level of 425 ppm since the leca was used during a previous season. In FIG. 25, there was an increase of 129% at the top and a decrease of 14% at the bottom. In FIG. 26, there was an increase of 156% at the top and a decrease of 33% at the bottom.

It may be concluded, therefore, that for a non-capillaric substrate, more chlorides accumulate at the bottom than at the top, whereas for a capillaric substrate, more chlorides accumulate at the top than at the bottom. As well known, various types of chlorides are dissolved within tap water and normally dissociate within stagnant water into anions and cations, which increase the electrical conductivity of water. Under normal circumstances, during which water continues to evaporate, the chloride level of the remaining water increases since chlorides have a much higher evaporation point than water and remain therein. However, with the use of the present invention and a capillaric substrate, chlorides accumulate at the top of the substrate, while the chloride concentration is minimal within the saturated layer, wherein a thick mass of roots grow. According to an explanation of the phenomenon reflected by the present invention, water together with the associated chlorides permeate the particulate material, and capillary force drives the chlorides upward towards the upper surface of the substrate. The chloride level within the controllable level of water does not significantly increase since the rate of capillarity is substantially equal to the rate of water influx into the corresponding container, and therefore there is a turnover of dissolved chlorides therein to thereby prevent a deleterious rise in chloride level.

### EXAMPLE 3

For the next set of experiments, tomato plants were grown in a net-house of 50 mesh during the winter of 2002 at the Agricultural Farm of Bar-Ilan University, located 10 km east of Tel-Aviv. The plants were grown in non-drained containers having a length of 1 m, a width of 0.5 m, a depth of 30 cm., and a controllable water layer of 3.5 cm, in accordance with the present invention, wherein each container was filled with two tiers of particulate material. The bottom tier was a depth of 25 cm and the capillaric particulate material was tuff and peat (1:1, v:v). The top tier had a depth of 5 cm and the capillaric particulate material was perlite. The same crop density as specified in relation to Experiment 5 below was used. For the first two weeks of growth, the type of fertilizer was Sheffer 666, and afterwards Sheffer 1 was used.

The plants were uprooted during March 2002 and the supply of fertilizer into the containers was immediately closed, while the water supply into the containers continued. The chloride concentration was measured at the following locations during each of six days following the uprooting of the tomato plants: 5 cm, 15 cm, 20 cm and 29 cm above the container bottom. Water, at these locations, was extracted from the particulate material by means of a syringe covered by a porous ceramic head, to prevent the inflow of soil. A vacuum was applied at the end of the syringe to allow for the slow passage of water from the upper, relatively dry layers of particulate material to the syringe.

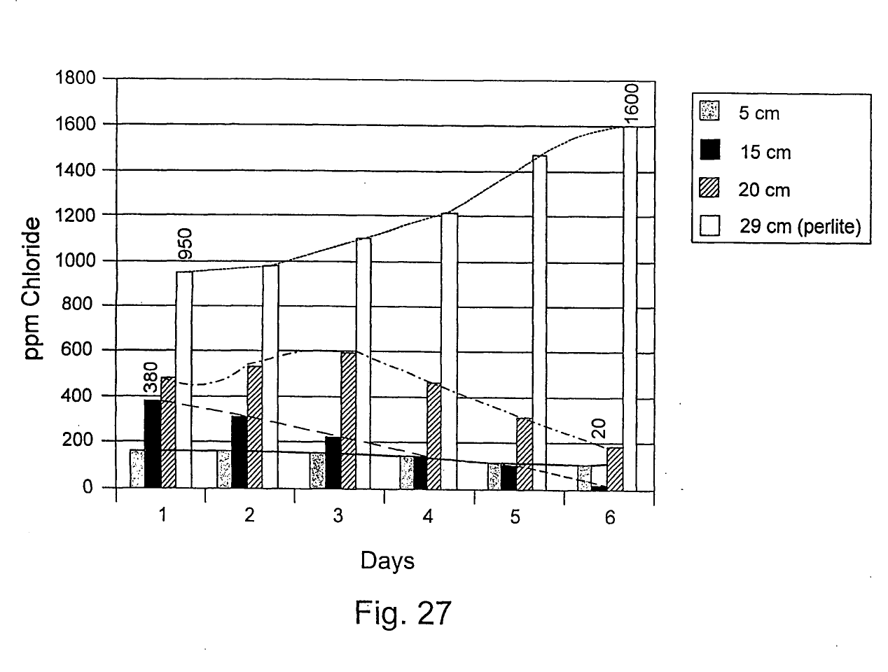

Day 0 of the experiment was designated as the day during which the plants were uprooted, causing a lowered rate of capillarity thereafter. As shown in FIG. 27, the chloride concentration at a height of 5 cm was relatively constant, having a decrease of only 37% from Day 1 to Day 6, since this location was located within the saturated layer. The chloride concentration at a height of 15 cm sharply decreased from 380 to 20 ppm, corresponding to a decrease of 95% from Day 1 to Day 6, due to a reduction in capillarity which normally drives the chlorides upward. The chloride concentration at a height of 20 cm fluctuated from 480 ppm during Day 1 to 590 during Day 3 due to the high rate of capillarity that had permeated from the saturated layer prior to Day 0, and then to 190 during Day 6 as a result of the reduced capillarity, a net decrease of 70%. The chloride concentration at a height of 29 cm sharply increased, having an increase of 168% from Day 1 to Day 6, from 950 ppm to 1600 ppm. Whereas the ratio of chloride concentration at a height of 29 cm to 15 cm is 11:1 at Day 1, the ratio is 55:1 at Day 6.

One may therefore conclude that a large majority of the chlorides that permeate upwards become concentrated within the top perlite tier. After discarding the perlite, the bottom tier of particulate material becomes relatively chloride-free, particularly if the perlite remains for a period much longer than 6 days, during which even a larger concentration of chlorides are drawn to the perlite.

Field Trials

The present invention has been implemented in a greenhouse, and field trials have indicated the surprising results that a water consumption of approximately one-quarter to one-fifth, relative to conventional water management systems, may be realized without any decrease in yield and without any deleterious increase in chlorides and contaminants.

### EXAMPLE 4

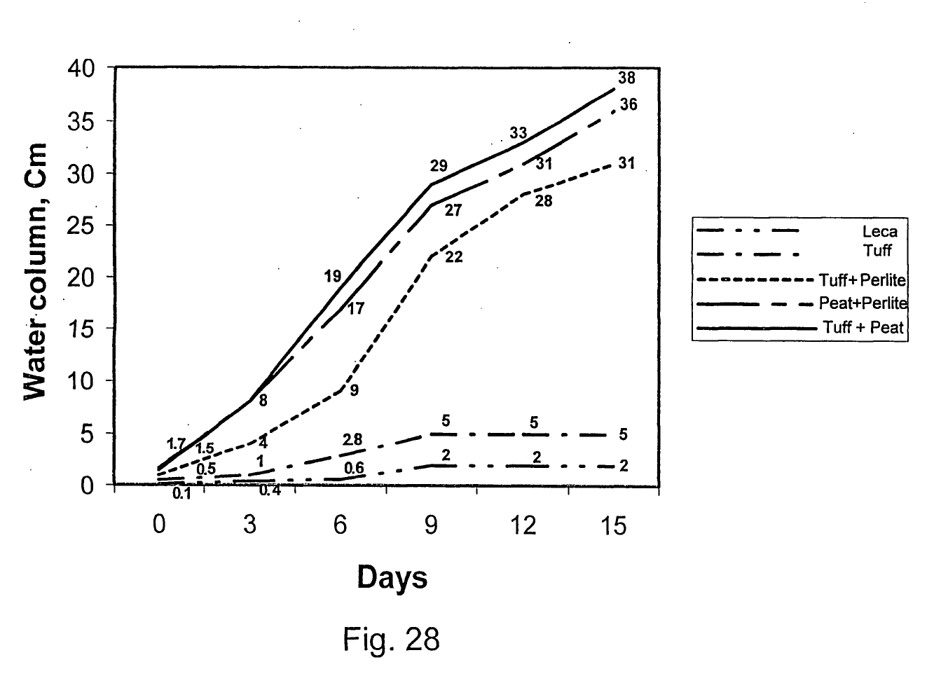

FIG. 28 is a graph which compares the rate of capillarity of water within five separate substrates. The temperature of the water ranged from 20-30° C. Each saturated substrate with a height of 2 cm is placed within a substrate column having a diameter of 20 cm and a height of 40 cm. The height of the water column above the substrate is measured after intervals of three days. As can be seen, the rate of capillarity of the substrate composed of tuff and peat has a rate of capillarity of approximately 2.5 cm/day, whereas leca has a rate of capillarity of approximately 0.1 cm/day. Tuff and leca supported a poor rate of capillarity, whereas substrates composed of peat and/or perlite exhibited an enhanced rate of capillarity. In this experiment, large tuff and large leca was used.

### EXAMPLE 5

Table V below details a summary of water consumption for crops grown with the implementation of the present invention during the winter in a non-heated growing house, between the period of Oct. 25, 2000 and Feb. 28, 2001. A comparison is made, for different crops, between data compiled by the Israeli Department of Agriculture, reflecting average water consumption, and the actual water consumption that resulted with the implementation of the present invention. The crops used for the experimentation is designated as: “B+P”—basil and pepper, “T”—tomato, “C”-cucumber.

The Israeli Department of Agriculture listed the total water consumption needed for various crops during both summer and winter months. The relevant values extracted from the statistics compiled by the Israeli Department of Agriculture are indicated on the two rightmost columns, and the column entitled “Summer” lists the values for crops grown during the summer months, while the column entitled “Winter” lists the values for crops grown during the winter months. The summer is defined as 4-5 months and the winter is defined as 8-9 months. The evaluation was performed on the basis of number of plants grown in a dunam. The term dunam indicates an area of 1000 m².

The same crop density as that of the Israeli Department of Agriculture was chosen as a basis for comparison, e.g. 15,000 basil plants per dunam and 2500 tomato plants per dunam. For each water meter, designated as “WM No.”, on which the experimentation was based, a different combination of types of bedding was used, such that 3 containers were used for each type of bedding, and 4 plants were grown in each container. For example, four different types of bedding were used in conjunction with Water Meter No. 1: a mixture of small leca and perlite, a mixture of small leca and peat, a mixture of small leca and perlite and a combination of large leca and peat.

For the 4 types of bedding, 12 containers were used and 48 plants were grown. Since two crops, basil and pepper, were grown in this group, the water consumption per dunam was not extrapolated, because each crop has a different crop density. For Water Meter No. 5, the total daily consumption for a group of 24 plants was 0.009 m³, or 0.00037 m³ per plant. By multiplying this value by the crop density of 2500 plants, an extrapolated daily value of 0.938 m³ per dunam was calculated, which is 253 m³ for 270 days of winter, a decrease of 79 percent in water consumption relative to the data compiled by the Israeli Department of Agriculture.

The area of each container is 0.5 m², the depth of each container is 20 cm and the depth of the controllable layer of water is 3.5 cm. Water was initially admitted to the containers when the various crops were planted. For the first two weeks of experimentation, the type of fertilizer was Sheffer 666, and afterwards Sheffer 1 was used.

TABLE V
Summary of Water Consumption in Winter (non-heated growing house)

| | | | No. | Per | Per | | | |
|---|---|---|---|---|---|---|---|---|
| | | | plants | Group/ | Plant/ | Per | | |
| WM | | | in a | day | day | Dunam | | |
| No. | Crops | Bedding | group | (m³) | (m³) | (m³) | Summer | Winter |
| 1 | B + P | 1 leca + perlite | 48 | 0.009 | 0.00018 | | Basil | Basil |
| | | 2 leca + peat | | | | | 500 m³/ | 800 m³/ |
| | | 3 leca + perlite | | | | | dunam | dunam |
| | | 4 large leca + peat | | | | | for | for |
| 2 | B + P | 1 leca | 24 | 0.0072 | 0.00030 | | 15000 | 15000 |
| | | 2 large leca | | | | | plants | plants |
| 3 | B + P | 1 large tuff | 84 | 0.027 | 0.00032 | | Pepper | Pepper |
| | | 2 large tuff + perlite | | | | | 1200 m³/ | 1500 m³ |
| | | 3 large tuff + peat | | | | | dunam | dunam |
| | | 4 tuff | | | | | for | for |
| | | 5 tuff + perlite | | | | | 3000 | 3000 |
| | | 6 tuff + peat | | | | | plants | plants |
| | | 7 perlite + peat | | | | | | |
| 4 | T | 1 leca + perlite | 48 | 0.036 | 0.0007 | 1.875 | 1200 m³/ | 1200 m³/ |
| | | 2 leca + peat | | | | | dunam | dunam |
| | | 3 leca + perlite | | | | | for | for |
| | | 4 large leca + peat | | | | | 2500 | 2500 |
| 5 | T | 1 leca | 24 | 0.009 | 0.00037 | 0.938 | plants | plants |
| | | 2 large leca | | | | | | |
| 6 | T | 1 large tuff | 84 | 0.0727 | 0.0008 | 2.16 | | |
| | | 2 large tuff + perlite | | | | | | |
| | | 3 large tuff + peat | | | | | | |
| | | 4 tuff | | | | | | |
| | | 5 tuff + perlite | | | | | | |
| | | 6 tuff + peat | | | | | | |
| | | 7 perlite + peat | | | | | | |
| 7 | C | 1 leca + perlite | 48 | 0.0136 | 0.00028 | 0.567 | 850 m³/ | 700 m³/ |
| | | 2 leca + peat | | | | | dunam | dunam |
| | | 3 large leca + perlite | | | | | for 2000 | for 2000 |
| | | 4 large leca + peat | | | | | plants | plants |
| 8 | C | 1 leca | 24 | 0.009 | 0.00037 | 0.750 | | |
| | | 2 large leca | | | | | | |
| 9 | C | 1 large tuff | 84 | 0.018 | 0.0002 | 0.429 | | |
| | | 2 large tuff + perlite | | | | | | |
| | | 3 large tuff + peat | | | | | | |
| | | 4 tuff | | | | | | |
| | | 5 tuff + perlite | | | | | | |
| | | 6 tuff + peat | | | | | | |
| | | 7 perlite + peat | | | | | | |

### EXAMPLE 6

Table VI below summarizes the winter yield of various crops that were grown with the implementation of the present invention, in terms of metric tons. This yield is compared with data provided by the Israeli Department of Agriculture for average yields during the winter and summer. For example, an average cucumber yield of 12 kg/month was realized for each container, which is equivalent to a yield of 1 kg/month per plant. This value is compared to the results of data compiled by the Israeli Department of Agriculture by multiplying the monthly yield per month by the number of plants grown per dunam in the compiled data, namely 2000 plants. This results in a total monthly yield per dunam of 2 metric tons, or a winter yield of 16 tons when calculating on a conservative basis of 8 months, an increase of 14 percent.

The same experimental conditions as those specified in relation to Experiment 5 above were used, namely the same types of crops were grown with the same crop density, the area of each container is 0.5 m², the depth of each container is 20 cm and the depth of the controllable layer of water is 3.5 cm. Water was initially admitted to the containers during the day when the crops were planted within each container. For the first two weeks of experimentation, the type of fertilizer was Sheffer 666, and afterwards Sheffer 1 was used.

TABLE VI
Summary of Winter Yield (sample comparison)

| | | | | | Agricultural Data | |
|---|---|---|---|---|---|---|
| | | | | | for non-heated | |
| | | | | | growing house | |
| | | | | Total | Total | Total |
| | Number | | Number | monthly | yield | yield |
| Type of | of plants/ | Total yield | of plants/ | yield per | winter | summer |
| Crop | bedding | (Yield/plant) | dunam | dunam | crop | crop |
| Tomatoes | 12 | 8 kg/2 weeks | 2500 | 3.33 ton | 15-18 ton | 12 ton |
| | | (1.33 kg/month) | | | | |
| Cucumber | 12 | 12 kg/month | 2000 | 2 ton | 12-14 ton | 8-10 ton |
| | | (1 kg/month) | | | | |
| Basil | 6 | 1 kg/2 months | 15000 | 1.25 ton | 10 ton | 12 ton |
| | | (83 g/month) | | | | |
| Pepper | 6 | 4 kg/2 months | 3000 | 1 ton | 6-8 ton | 11-13 ton |
| | | (333 g/month) | | | | |

### EXAMPLE 7

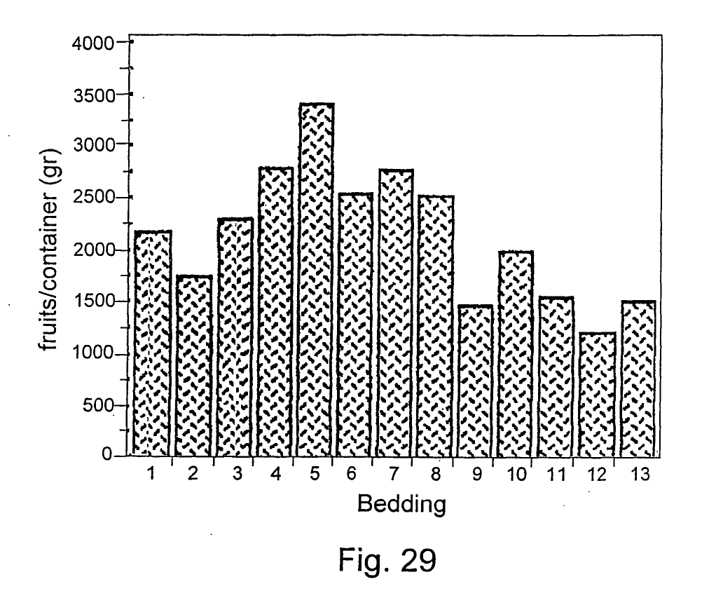

FIG. 29 is a graph of typical yields of tomato produced with the implementation of the present invention during the period between Jan. 28-Feb. 11, 2001. The graph indicates that the yield is dependent upon the type of porous bed used. As referred to in the graphs hereinafter, the following designations will be used for the different types of bedding:

1—small leca and perlite

2—small leca

3—small leca and peat

4—large leca

5—large leca and perlite

6—large leca and peat

7—large peat

8—large tuff and perlite

9—large tuff and peat

10—small tuff

11—small tuff and perlite

12—small tuff and peat

13—perlite and peat

14—large tuff

15—sand

For all of the different types of mixtures, a blend of 50 percent was used. The same experimental conditions as those specified in relation to Experiment 5 above were used, namely the same types of crops were grown with the same crop density, the area of each container is 0.5 m², the depth of each container is 20 cm and the depth of the controllable layer of water is 3.5 cm. Water was initially admitted during which the crops were planted. For the first two weeks of experimentation, the type of fertilizer was Sheffer 666, and afterwards Sheffer 1 was used.

### EXAMPLE 8

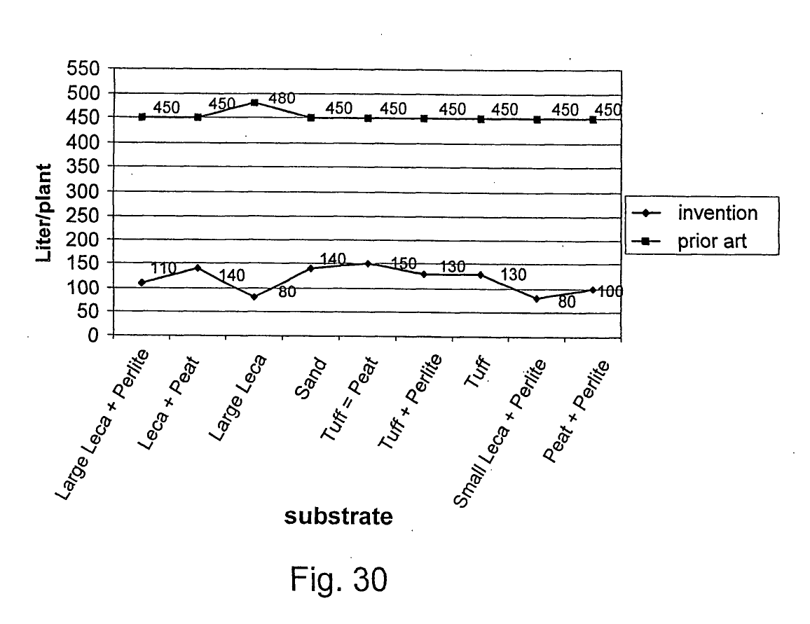

FIGS. 30-37 reflect the water consumption and yield for vegetable growth grown within a non-heated greenhouse with the implementation of the present invention during the summer of 2001, a period of 4 months. The same experimental conditions as those specified in relation to Experiment 5 above were used, namely the same types of crops were grown with the same crop density, the area of each container is 0.5 m², the depth of each container is 20 cm and the depth of the controllable layer of water is 3.5 cm. Water was initially admitted to the containers during the day when one month-old seedlings were planted within each container. One of 9 different substrates was planted in each container. For the first two weeks of experimentation, the type of fertilizer was Sheffer 666, and afterwards Sheffer 1 was used.

A graphic comparison is made relative to the recommendations of the Israeli Ministry of Agriculture regarding water consumption of various crops in detached substrates during the summer months. According to these recommendations, average water consumption for tomatoes in a greenhouse is 1200 m³/dunam corresponding to a plant density of 2500 plants/dunam and is 700 m³/dunam corresponding to a plant density of 2000 plants/dunam for cucumbers grown in a greenhouse. Drained containers were irrigated with drip irrigation hoses placed on the upper surface of the substrate, while non-drained containers implemented according to the present invention were irrigated with similar hoses inserted into the substrate at 10 cm above the bottom of the container. Once again the required average water consumption is one-quarter to one-fifth that of the prior art methods and the associated yields are equivalent to, and even slightly higher than, the prior art methods.

FIG. 30 compares the total water consumption for the Hazera 189 species of tomato during 100 growing days. A large difference in water consumption between the two different types of containers was realized-450-480 liters per plant were consumed in 100 days by tomatoes grown in drained containers in contrast to 80-150 liters per plant grown according to the method of the present invention, an amount of water conservation ranging between 69-83%. The various substrates differed in water consumption, with large leca consuming the lowest volume of water, 80 liters.

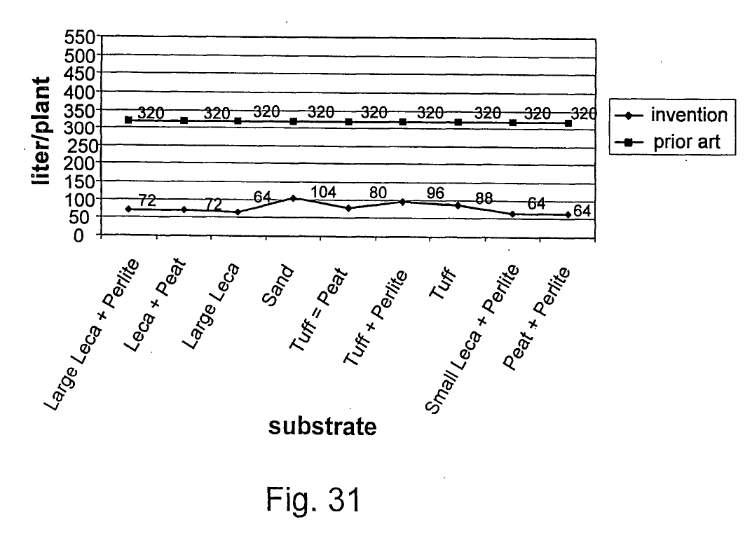

FIG. 31 compares the total water consumption for the Hasan species of cucumber during 100 growing days. A large difference in water consumption between the two different types of containers was realized-320 liters per plant were consumed in 100 days by cucumbers grown in drained containers in contrast to 64-104 liters per plant grown according to the method of the present invention, an amount of water conservation ranging between 67-80%.

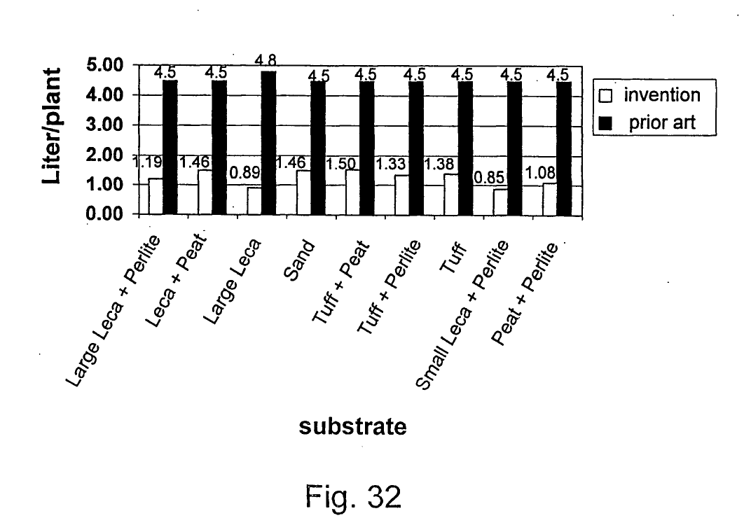

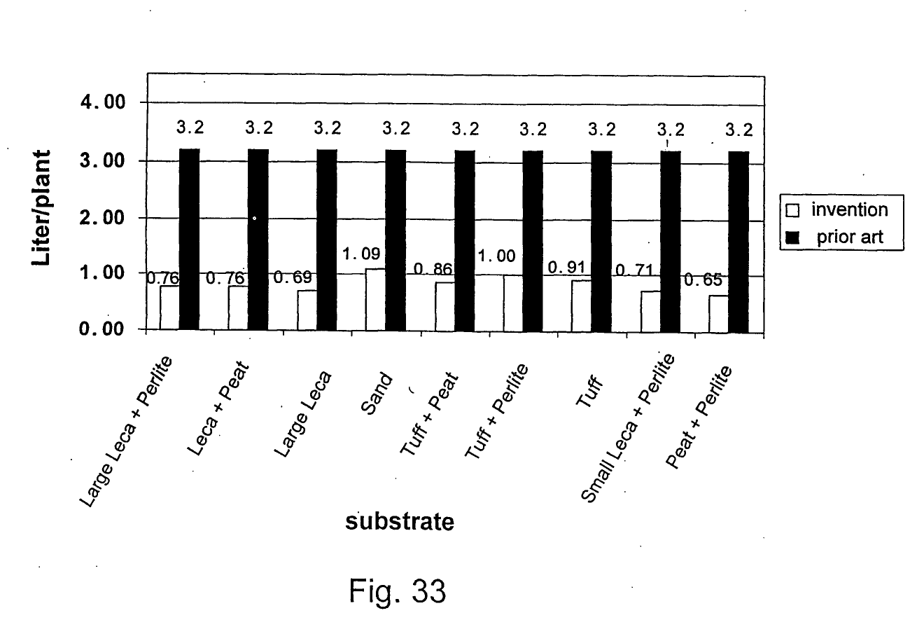

FIGS. 32 and 33 compare the mean daily water consumption for the two aforementioned crops, respectively.

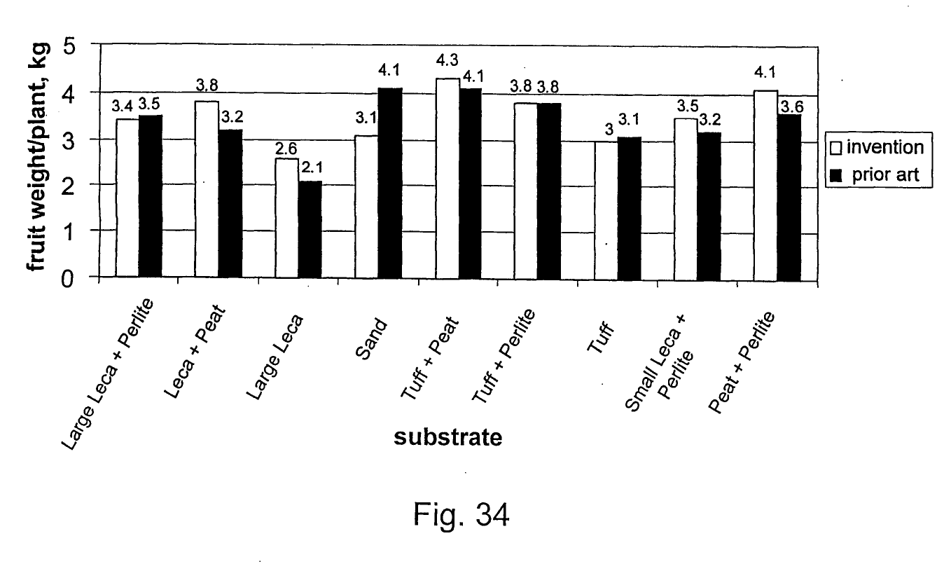

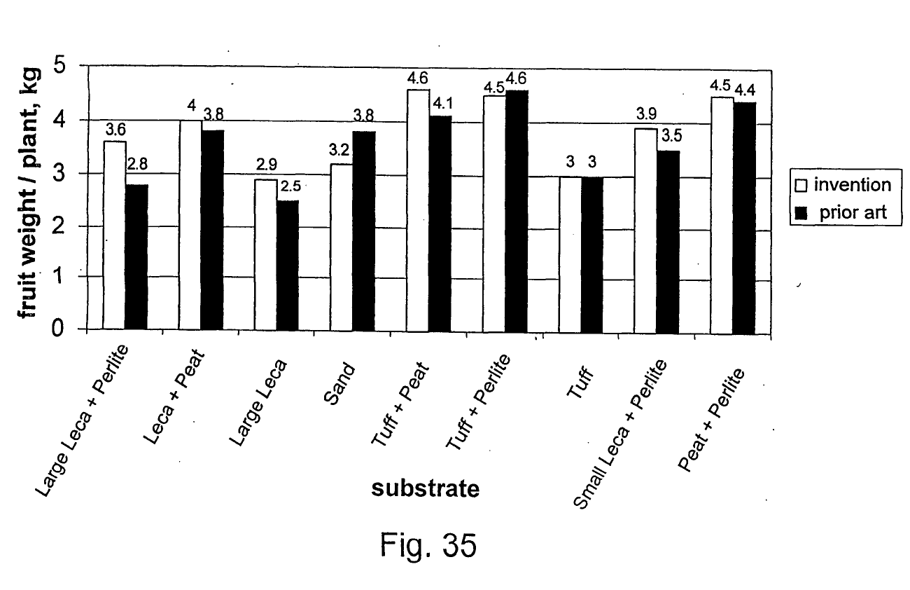

FIGS. 34 and 35 compare yield data for the two aforementioned crops, respectively, in terms of total fruit weight per plant during 100 days. For tomatoes, higher yields were obtained for crops grown according to the method of the present invention than for crops grown in drained containers for 5 of 9 substrates. With sand, lower yields were obtained, while for 3 substrates, the yields were substantially equal for drained and non-drained containers. Similar results were obtained with cucumber yields, and sand was the only substrate that reduced the yield for crops grown in accordance with the present invention. Large leca supported the lowest yield. Highest yield was supported by tuff+peat.

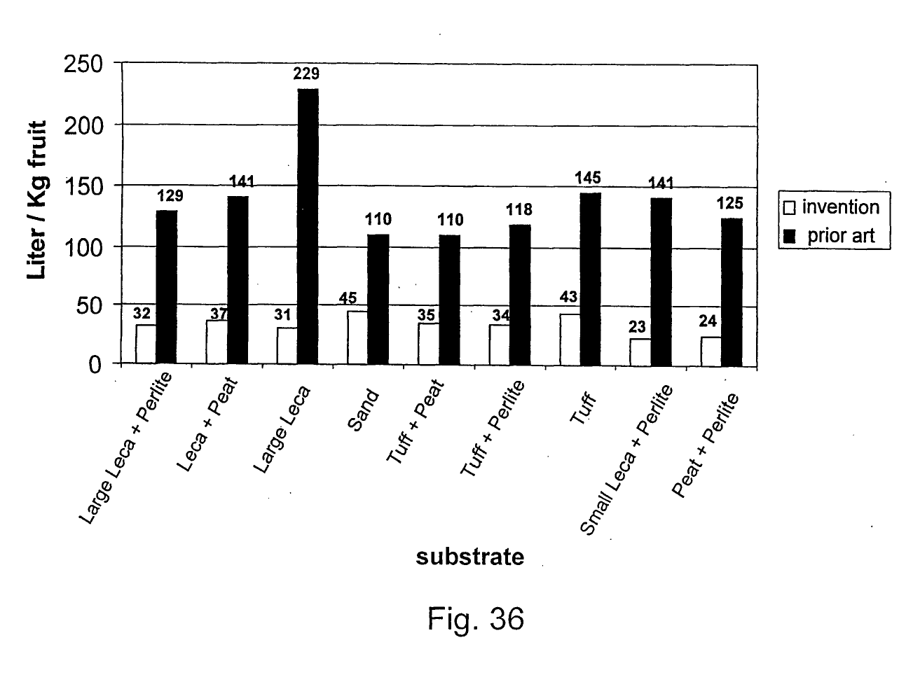

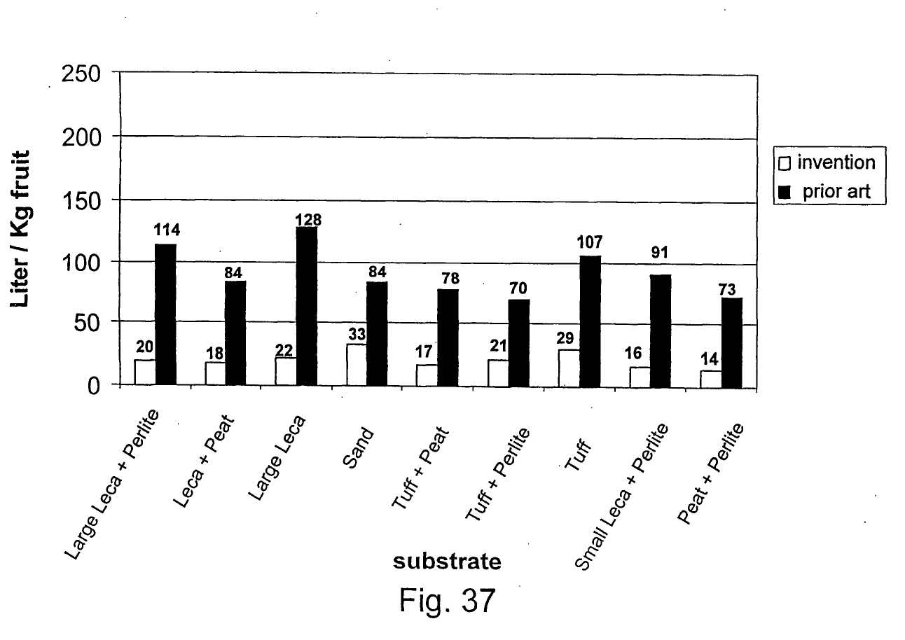

FIGS. 36 and 37 compare the yield ratio for the two aforementioned crops, respectively. The total water consumption of a plant during 100 days was divided by the total fruit weight during this period. For example, a yield ratio of 450/4.1=110 liter/kg was obtained for tomatoes grown in a drained container and 150/4.3=35 liter/kg for those grown according to the present invention, reflecting a high level of water conservation with use of the present invention.

As described above, significant savings in water and fertilizer may be realized with the implementation of the present invention by controlling the water level within a plurality of containers in each of which plant growth is cultivated, without any decrease in yield and without any deleterious increase in chlorides. The ecological impact of the present invention is also of large importance, due to a reduced load on the local aquifer without inducing an increase of pathogens therein.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A water-efficient method for growing plants in at least one container, comprising the steps of:
a. providing at least one container having at least one water inlet;
b. providing in each of said containers a porous bed of particulate material;
c. providing at least one drainage opening in each of said containers at a level intermediate between the top and the bottom of said porous bed, wherein said drainage opening divides said particulate material into a lower saturated layer below said level and an upper, relatively dry layer above said level;
d. providing, in one or more of said containers, water level gauging means to gauge the depth of the layer of water existing at the bottom of said one or more containers;
e. planting plant growth in said containers; and
f. adding water to each of said containers as a result of the reading of said water level gauging means, so as to maintain a desired level of water at the bottom of the gauged container.

2. The method of claim 1, wherein the particulate material is an inert material.

3. The method of claim 2, wherein the inert material is chosen in the group consisting of peat, tuff, perlite, leca or mixtures thereof.

4. The method of claim 1, wherein two or more containers are gauged, and water is added when the level of water in said two or more containers, averaged according to a predetermined averaging rule, reaches a first predetermined value.

5. The method of claim 4, further comprising providing orifices for drainage of water having a depth greater than a second predetermined value.

6. The method of claim 5, wherein the water level gauging means is a sensor.

7. The method of claim 6, wherein the sensor is coupled to a control valve, said control valve being actuatable to add water as the sensor detects a water level below the first predetermined water level.

8. The method of claim 7, wherein the control valve is actuatable to prevent addition of water as the sensor detects a water level above the second predetermined water level.

9. The method of claim 6, wherein the sensor is chosen in the group consisting of level switches, interphase sensors and capacitive transduction sensors.

10. The method of claim 7, wherein the control valve is actuatable to control the flow of water through a water line into a set of containers.

11. The method of claim 1 claims, wherein the water level gauging means consists of a plurality of sensors, each sensor being disposed in a different container.

12. The method of claim 11, wherein each sensor is in communication with a controller, said controller processing the data acquired from said sensors to thereby control the actuation of the control valve.

13. The method of claim 12, wherein the controller controls the actuation of a plurality of control valves, each of said control valves being actuatable to add water to a different set of containers.

14. The method of claim 12, wherein each control valve is actuatable to add water from a different water line.

15. The method of claim 1, wherein the desired level of water ranges from 1 to 7 cm.

16. The method of claim 12, further comprising pumping liquid fertilizer to the water inlet of a set of containers.

17. The method of claim 16, wherein the controller maintains a predetermined ratio of fertilizer to water.

18. The method of claim 1, wherein water is provided to each container by one or more methods selected from sprinkler irrigation, drip irrigation or underground irrigation, said layer of water being formed along the bottom of each container by an accumulation of any excess water not absorbed by the roots of the plant growth or not absorbed by the particulate material.

19. The method of claim 1, wherein the particulate material is capillaric.

20. The method of claim 19, further comprising the steps of allowing chlorides to permeate the particulate material and preventing a deleterious rise in chloride level within the desired level of water.

21. The method of claim 20, further comprising the steps of:
a) providing a top tier and a bottom tier of particulate material in one or more of the containers, said top tier being provided with a particulate material having a water adsorption of at least 200% by weight;
b) allowing chlorides to concentrate in said top tier;
c) removing said top tier upon conclusion of a plant growing season;
d) reusing said bottom tier during a subsequent growing season;
e) providing a different top tier; and
f) planting another plant growth in said different top tier.

22. The method of claim 21, wherein the top tier has an apparent density ranging from 40 to 170 kg/m³, and is removed upon conclusion of a plant growing season by a hand held implement.

23. A water-efficient water management system for growing plants in at least one container, comprising:
a) at least one container wherein each of which is suitable to contain a bed of particulate material;
b) at least one water inlet and at least one drainage opening to each of said containers, at a level intermediate between the top and the bottom of said bed of particulate material, wherein said at least one drainage opening divides said bed into a lower saturated layer below said level and an upper, relatively dry layer above said level;
c) water level gauging means provided in one or more of said containers, to gauge the depth of a layer of water existing at the bottom of said one or more containers; and
d) water control means to add water to said containers as a result of the reading of said water level gauging means, so as to maintain a desired level of water at the bottom of the gauged container.

24. A system according to claim 23, wherein each of the containers contain a bed of particulate material.

25. The system of claim 24, comprising averaging means to average the level of water in two or more containers according to a predetermined averaging rule.

26. The system of claim 23, comprising a microprocessor.

27. The system of claim 26, wherein the microprocessor receives water level data from the water level gauging means.

28. The system of claim 23, wherein the microprocessor controls the water control means according to the water level data.

29. The system of claim 28, wherein the water control means is at least one control valve and the water level gauging means is at least one sensor, said at least one control valve being operative in response to said at least one sensor to admit an additional amount of water to a corresponding container at a predetermined flow rate for a predetermined duration when the water level falls below a first predetermined value.

30. The system of claim 29, wherein the sensitivity of the sensor is such that the rate of water influx into the corresponding container is substantially equal to the rate of water level decrease.

31. The system of claim 29, further comprising a controller which controls the actuation of each control valve in response to signals transmitted by the sensor.

32. The system of claim 29, wherein the sensor is a level switch.

33. The system of claim 32, wherein the level switch is comprised by a float, cable, and sensor housing, said sensor housing being partially open at its bottom to thereby allow water to enter therein, whereby said float rises and descends within said sensor housing in response to the water level therein.

34. The system of claim 29, wherein the sensor is an interphase sensor.

35. The system of claim 29, wherein the sensor is a soil moisture sensor.

36. The system of claim 29, wherein the sensor is a capacitive transduction sensor.

37. The system of claim 36, wherein an inner and an outer electrode are not in contact with a water column having a variable height, water of said water column being admitted from the layer of water existing at the bottom of a corresponding container to a groove formed within an electrode housing and located between said inner and outer electrodes, whereby the sensor senses an instantaneous capacitance between said inner and outer electrodes and transduces said instantaneous capacitance into an output voltage.

38. The system of claim 37, wherein first and second plastic partitions separate the water column from the inner and outer electrodes, respectively.

39. The system of claim 23, further comprising means for heating the layer of water.

40. The system of claim 39, wherein the heating means consists of a heater to heat the water flowing into the inlet to each of the containers.

41. The system of claim 23 further comprising at least one drainage orifice, said at least one drainage orifice being disposed at such a position within the container walls so as to allow for drainage when the water level rises above a second predetermined value.

42. The system of claim 41, further comprising a drainage unit, said drainage unit being insertable into each orifice by means of a stem having a rotatable element such that the drainage of water from the corresponding container passes therethrough.

43. The system of claim 42, wherein the drainage unit is rotatable, whereby at one rotational position drainage is possible, at a second rotational position drainage from the corresponding container is prevented, and at an intermediate rotational position partial drainage is effected.

44. The system of claim 23, wherein each of the containers is provided with a container bottom.

45. The system of claim 44, wherein each container bottom is provided with at least one closable drainage aperture to allow for complete drainage of the layer of water.

46. The system of claim 24, wherein the particulate material is capillaric.

47. The system of claim 24, wherein the particulate material is selected from the group consisting of peat, tuff, perlite, leca, sand or mixtures or blends of such materials.

48. The system of claim 47, wherein the water holding capacity of the particulate material is at least 0.035.

49. The system of claim 40, wherein the particulate material comprises at least two tiers.

50. The system of claim 49, wherein the lower tier has a larger particle size than an upper one.

51. The system of claim 49, wherein the uppermost tier has a water adsorption of at least about 200% by weight.

52. The system of claim 51, wherein the uppermost tier has an apparent density ranging from 40 to 170 kg/m³.

53. The system of claim 23, wherein the water inlet to each container is comprised by a flexible perforated hose imbedded at a predetermined height below the surface of the particulate material.

54. The system of claim 31, further comprising a fertilization pump, said pump delivering fertilizer to the water inlet of a set of containers.

55. The system of claim 54, wherein the controller controls the actuation of the fertilization pump in response to signals transmitted by the sensor.

56. A water supply controller for carrying out the system of claim 23 by controlling the supply of water to a plant growth vessel in response to a water level indication of a body of water in a vessel, wherein said vessel comprises vessel walls, a vessel bottom, a bed of porous material contained in said vessel, and plant growth, the roots of which extend into said bed of porous material, said controller comprising water level gauging means suitable to sense the level of water existing at the bottom of said container.

57. The water supply controller of claim 56, operative to control the actuation of a control valve in response to said water level indication.

58. The water supply controller of claim 57, comprising a microprocessor, software for programming the actuator in a predefined manner, a local memory and a means of communicating with the control valve actuator and water level gauging means.

59. The water supply controller of claim 58, wherein the water level gauging means is a sensor selected from the group of level switch, interphase sensor, capacitive transduction sensor and soil moisture sensor.

60. The water supply controller of claim 57, wherein the control valve is operative to admit an additional amount of water to a plurality of vessels at a predetermined flow rate for a predetermined duration.

61. The water supply controller of claim 60, operative to receive signals from a plurality of sensors and to process the signals whereby to command the control valve actuator to regulate the inflow into the vessels in accordance with the program, each of said sensors being disposed in a different vessel.

62. The water supply controller of claim 57, operative to control the actuation of a plurality of control valves, each of said control valves being actuatable to add water to a different set of vessels.

63. In a bed of porous material contained in a vessel as recited in claim 1, at the bottom of which a predetermined level of water is controllably maintained, a plant having a primary root branched into secondary roots and the secondary roots which have developed into plagiotropically growing root hairs characterized by a fibrous root system, said secondary roots being capable of growing and extending through said bed of porous material, said root hairs being capable of extending into, and being entwined with, a layer of said porous material saturated by said level of water, whereby to form a biomass within said saturated layer.

64. Root-mutated plant of claim 63, wherein the primary root of a tap root system has branched into root hairs of a fibrous root system.

65. A plant growth according to claim 63, induced by:
a) a container filled with particulate material;
b) at least one water inlet and at least one drainage opening provided in said container; and
c) water control means to add water to said container, so as to maintain the desired level of water at the bottom of the gauged container, wherein a primary root branches into secondary roots and the secondary roots develop into plagiotropically growing root hairs characterized by a fibrous root system, said secondary roots capable of growing and extending through said particulate material, said root hairs extending into and being entwined with a layer of said particulate material saturated by said level of water, whereby to form a biomass within said saturated layer.
